(19) United States
(12) Patent Application Publication
(10) Pub. No.: US 2024/0406195 A1
(43) Pub. Date: Dec. 5, 2024

(54) INTERACTIVE EXTENSION FOR A CYBERSECURITY APPLIANCE

(71) Applicant: Darktrace Holdings Limited, Cambridge (GB)

(72) Inventors: David Sansom, Crediton (GB); Jack Stockdale, Cambridge (GB); Matthew Dunn, Ely (GB); Stephen Pickman, Huntingdon (GB); Constance Stride, Cambridge (GB); William Hodkinson, Salford (GB)

(21) Appl. No.: 18/678,545

(22) Filed: May 30, 2024

Related U.S. Application Data
(60) Provisional application No. 63/470,571, filed on Jun. 2, 2023.
(60) Provisional application No. 63/470,572, filed on Jun. 2, 2023.
(60) Provisional application No. 63/528,009, filed on Jul. 20, 2023.

(51) Int. Cl. H04L 9/40

(52) U.S. Cl. CPC H04L 63/1416

(57) ABSTRACT

In an embodiment, an apparatus is described. The apparatus comprises an appliance extension configured to perform functions with i) a monitoring module configured to monitor metrics and receive alerts regarding potential cyber threats on a system including an email system, ii) an investigative module configured to retrieve the metrics and alerts, and iii) a remote response module configured observe the metrics and alerts and send one or more control signals to an autonomous response module to take one or more actions to counter one or more detected cyber threats on the system remotely from the appliance extension. The apparatus extension is configured to display one or more of the metrics, alerts, and one or more actions of the remote response module on an interactive user interface, the interactive user interface being configured to receive one or more user inputs from a user to control or modify the one or more actions, where the appliance extension is further configured to provide a secure extension of a second user interface of a cyber security appliance installed in the system.

### RELATED APPLICATION

This application claims priority under 35 USC 119 to U.S. provisional patent application No. 63/470,571, titled “A CYBER SECURITY SYSTEM” filed 2 Jun. 2023, U.S. provisional patent application No. 63/470,572, titled “A CYBER SECURITY SYSTEM” filed 2 Jun. 2023, and to U.S. provisional patent application No. 63/528,009, titled “A CYBER SECURITY LOOP” filed 20 Jul. 2023, which the disclosures of such are incorporated herein by reference in their entirety.

### NOTICE OF COPYRIGHT

A portion of this disclosure contains material that is subject to copyright protection. The copyright owner has no objection to the facsimile reproduction by anyone of the material subject to copyright protection as it appears in the United States Patent & Trademark Office's patent file or records, but otherwise reserves all copyright rights whatsoever.

### FIELD

Cyber security and in an embodiment use of Artificial Intelligence in cyber security.

### BACKGROUND

Cybersecurity attacks have become a pervasive problem for enterprises as many computing devices and other resources have been subjected to attack and compromised. A “cyberattack” constitutes a threat to security of an enterprise (e.g., enterprise network, one or more computing devices connected to the enterprise network, or the like). As an example, the cyberattack may be a cyber threat against the enterprise network, one or more computing devices connected to the enterprise network, stored or in-flight data accessible over the enterprise network, and/or other enterprise-based resources. This cyber threat may involve malware (malicious software) introduced into a computing device or into the network. The cyber threat may originate from an external endpoint or an internal entity (e.g., a negligent or rogue authorized user). The cyber threats may represent malicious or criminal activity, ranging from theft of credential to even a nation-state attack, where the source initiating or causing the security threat is commonly referred to as a “malicious” source. Conventional cybersecurity products are commonly used to detect and prioritize cybersecurity threats (hereinafter, “cyber threats”) against the enterprise, and to determine preventive and/or remedial actions for the enterprise in response to those cyber threats.

### SUMMARY

Methods, systems, and apparatus are disclosed for an Artificial Intelligence (AI)-based cyber security system.

In one aspect, apparatus is described in which an appliance extension may cooperate with a cyber security appliance. The appliance extension is configured to perform multiple functions. The appliance extension includes a monitoring module configured to monitor metrics and receive alerts regarding potential cyber threats on a system including an email system. The appliance extension includes an investigative module configured to retrieve the metrics and alerts. The appliance extension includes a remote response module configured to observe the metrics and alerts and send one or more control signals to an autonomous response module to take one or more actions to counter one or more detected cyber threats on the system remotely from the appliance extension. The appliance extension is configured to display one or more of the metrics, alerts, and one or more actions of the remote response module on an interactive user interface, the interactive user interface being configured to receive one or more user inputs from a user to control or modify the one or more actions. The appliance extension is configured to provide a secure extension of a second user interface of a cyber security appliance installed in the system.

In another aspect, a method for an appliance extension for a cyber security appliance is described. The method comprises configuring the appliance extension to perform functions with i) a monitoring module configured to monitor metrics and receive alerts regarding potential cyber threats on a system including an email system, ii) an investigative module configured to retrieve the metrics and alerts, and iii) a remote response module configured observe the metrics and alerts and send one or more control signals to an autonomous response module to take one or more actions to counter one or more detected cyber threats on the system remotely from the appliance extension; configuring the appliance extension to display one or more of the metrics, alerts, and one or more actions of the remote response module on an interactive user interface; configuring the interactive user interface to receive one or more user inputs from a user to control or modify the one or more actions; and configuring the appliance extension to provide a secure extension of a second user interface of a cyber security appliance installed in the system.

In another aspect, a non-transitory computer-readable medium is described, comprising computer readable code operable, when executed by one or more processing apparatuses in a computer system to instruct a computing device to perform the method according to embodiments described herein.

These and other features of the design provided herein can be better understood with reference to the drawings, description, and claims, all of which form the disclosure of this patent application.

### DRAWINGS

The drawings refer to some embodiments of the design provided herein in which:

FIG. 1 illustrates a block diagram of an embodiment of an appliance extension with a number of different modules to perform various functions.

FIG. 2 illustrates a block diagram of an example appliance extension with instances of the mobile application resident on each mobile device i) to have access to and ii) communication with the cyber defense appliance installed in the system.

FIG. 3a illustrates a diagram of an example appliance extension with a monitoring module and an investigative module cooperating with the interactive user interface to retrieve, display, and enable interaction with metrics on potential cyber threats causing a model breach.

FIG. 3b illustrates a diagram of an example appliance extension with a monitoring module and an investigative module cooperating with the interactive user interface to retrieve, display, and enable interaction with metrics on potential cyber threats causing a model breach.

FIG. 4a illustrates a diagram of an example appliance extension with a monitoring module and an investigative module cooperating with the interactive user interface to retrieve, display, and enable interaction with metrics on potential cyber threats causing a model breach in a graph format.

FIG. 4b illustrates a diagram of an example appliance extension with a monitoring module and an investigative module cooperating with the interactive user interface to retrieve, display, and enable interaction and customization with metrics on potential cyber threats causing a model breach.

FIG. 5a illustrates a diagram of an example appliance extension with a monitoring module and an investigative module cooperating with the interactive user interface to retrieve, display, and enable interaction with metrics on potential cyber threats causing a model breach including email filtering.

FIG. 5b illustrates a diagram of an example appliance extension with a monitoring module and an investigative module cooperating with the interactive user interface to retrieve, display, and enable interaction with metrics on potential cyber threats causing a model breach including email filtering.

FIG. 6a illustrates a diagram of an example appliance extension with a monitoring module and an investigative module cooperating with the interactive user interface to retrieve, display, and enable interaction with metrics on potential cyber threats causing a model breach related to threat categories.

FIG. 6b illustrates a diagram of an example appliance extension with a monitoring module and an investigative module cooperating with the interactive user interface to retrieve, display, and enable interaction with metrics on potential cyber threats causing a model breach including email filtering by a threat category.

FIG. 7a illustrates a diagram of an example appliance extension with a monitoring module and an investigative module cooperating with the interactive user interface to retrieve, display, and enable interaction with metrics on potential cyber threats causing a model breach including interacting with an email.

FIG. 7b illustrates a diagram of an example appliance extension with a monitoring module and an investigative module cooperating with the interactive user interface to retrieve, display, and enable interaction with metrics on potential cyber threats causing a model breach including interacting with an email.

FIG. 8a illustrates a diagram of an example appliance extension with a monitoring module and an investigative module cooperating with the interactive user interface to retrieve, display, and enable interaction with a contextualized summary of potential cyber threats causing a model breach.

FIG. 8b illustrates a diagram of an example appliance extension with a monitoring module and an investigative module cooperating with the interactive user interface to retrieve, display, and enable interaction with an email related to a potential cyber threat.

FIG. 9a illustrates a diagram of an example appliance extension with a monitoring module and an investigative module cooperating with the interactive user interface to retrieve, display, and enable interaction with a contextualized summary and additional data of an email related to a potential cyber threat.

FIG. 9b illustrates a diagram of an example appliance extension with a monitoring module and an investigative module cooperating with the interactive user interface to retrieve, display, and enable interaction with a contextualized summary and additional contextual data of an email related to a potential cyber threat.

FIG. 10a illustrates a diagram of an example appliance extension with a monitoring module, an investigative module, and autonomous response module cooperating with the interactive user interface to retrieve, display, and enable interaction with an email related to a potential cyber threat.

FIG. 10b illustrates a diagram of an example appliance extension with a monitoring module, an investigative module, and autonomous response module cooperating with the interactive user interface to retrieve, display, and enable interaction with an email related to a potential cyber threat and control the autonomous response of the autonomous response module.

FIG. 11 illustrates a diagram of an example appliance extension with a monitoring module and an investigative module cooperating with the interactive user interface to retrieve, display, and enable interaction with a contextualized summary and additional contextual data of an email campaign related to a potential cyber threat.

FIG. 12a illustrates a diagram of an example appliance extension with a monitoring module and an investigative module cooperating with the interactive user interface to retrieve, display, and enable interaction with a Proactive Threat Notification.

FIG. 12b illustrates a diagram of an example appliance extension with a monitoring module and an investigative module cooperating with the interactive user interface to retrieve, display, and enable interaction with a Proactive Threat Notification.

FIG. 13 illustrates a block diagram of an embodiment of the AI-based cyber security appliance with example components making up a detection engine that protects a system, including but not limited to a network/domain, from cyber threats.

FIG. 14 illustrates a block diagram of an embodiment of example autonomous actions automatically conducted by the autonomous response module.

FIG. 15 illustrates a diagram of an embodiment of i) the cyber threat detection engine using Artificial Intelligence algorithms configured and trained to perform a first machine-learned task of detecting the cyber threat, ii) an autonomous response engine using Artificial Intelligence algorithms configured and trained to perform a second machine-learned task of taking one or more mitigation actions to mitigate the cyber threat, iii) a cyber-security restoration engine using Artificial Intelligence algorithms configured and trained to perform a third machine-learned task of remediating the system being protected back to a trusted operational state, and iv) a cyber-attack simulator using Artificial Intelligence algorithms configured and trained to perform a fourth machine-learned task of Artificial Intelligence-based simulations of cyberattacks to assist in determining 1) how a simulated cyberattack might occur in the system being protected, and 2) how to use the simulated cyberattack information to preempt possible escalations of an ongoing actual cyberattack, working in tandem.

FIG. 16 illustrates a block diagram of an embodiment of the cyber-attack simulator with Artificial Intelligence-based simulations conducted in the cyber-attack simulator by constructing a graph of nodes of the system being protected (e.g. a network including i) the physical devices connecting to the network, any virtualize machines of the network, user accounts in the network, email accounts in the network, etc. as well as ii) connections and pathways through the network) to create a simulated version of the system to be tested.

FIG. 17 illustrates a diagram of an embodiment of a cyber threat cyber-attack simulator and its Artificial Intelligence-based simulations constructing a graph of nodes in an example network and simulating how the cyberattack might likely progress in the future tailored with an innate understanding of a normal behavior of the nodes in the system being protected and a current operational state of each node in the graph of the protected system during simulations of cyberattacks.

FIG. 18 illustrates a block diagram of an embodiment of the AI-based cyber security appliance with the cyber security restoration engine and other Artificial Intelligence-based engines plugging in as an appliance platform to protect a system.

FIG. 19 illustrates a graph of an embodiment of an example chain of unusual behavior for, in this example, the email activities and IT network activities deviating from a normal pattern of life in connection with the rest of the system/network under analysis.

FIG. 20 illustrates a block diagram of an embodiment of one or more computing devices that can be a part of the Artificial Intelligence-based cyber security system including the multiple Artificial Intelligence-based engines discussed herein.

FIG. 21 illustrates a block diagram of an embodiment of the AI-based cyber security appliance with the cyber security restoration engine and other Artificial Intelligence-based engines plugging in as an appliance platform to protect a system.

FIG. 22 is a flowchart of a method 2000 to implement a technique described herein.

While the design is subject to various modifications, equivalents, and alternative forms, specific embodiments thereof have been shown by way of example in the drawings and will now be described in detail. It should be understood that the design is not limited to the particular embodiments disclosed, but—on the contrary—the intention is to cover all modifications, equivalents, and alternative forms using the specific embodiments.

### DESCRIPTION

In the following description, numerous specific details are set forth, such as examples of specific data signals, named components, number of servers in a system, etc., in order to provide a thorough understanding of the present design. It will be apparent, however, to one of ordinary skill in the art that the present design can be practiced without these specific details. In other instances, well known components or methods have not been described in detail but rather in a block diagram in order to avoid unnecessarily obscuring the present design. Further, specific numeric references such as a first server, can be made. However, the specific numeric reference should not be interpreted as a literal sequential order but rather interpreted that the first server is different than a second server. Thus, the specific details set forth are merely exemplary. Also, the features implemented in one embodiment may be implemented in another embodiment where logically possible. The specific details can be varied from and still be contemplated to be within the spirit and scope of the present design. The term coupled is defined as meaning connected either directly to the component or indirectly to the component through another component.

Cybersecurity threats detected on a system and action taken by a cybersecurity defense system may involve at least some level of interaction from a user. Typically, such interaction requires a user of a system protected by a cybersecurity defense system to access a cybersecurity appliance to enable a user to review cybersecurity data related to a cybersecurity threat and review actions taken to counter the cybersecurity threat. This cybersecurity data can be vast, and the access to such data requires a user to log into the cyber security appliance and investigate potential cyber threats at a location where the cyber security appliance is installed in the system.

The inventors of the present disclosure have appreciated the need to enable a user to interact with cybersecurity data in a simplified, human-readable format, and to enable a user with the ability to interact with (control or modify) the actions taken by one or mode AI-based modules in a cybersecurity system. Arrangements of the present disclosure therefore enable the user in this way through an interactive mobile application and appliance extension. The inventors have also appreciated the need to provide contextual information to enable a user to further investigate cybersecurity threats on a system, thereby empowering the user to take action or control the actions of one or more AI-modules protecting a system in response to cybersecurity threats conveniently and efficiently from, for example, a mobile device.

Providing the appliance extension in accordance with embodiments described herein allows for wider adoption of autonomous response technology and managed autonomous detection and response by enabling users to interact with a simplified cybersecurity system where the use can enact autonomous actions, modify the outputs from autonomous actions, and interact with a human-readable data format for cybersecurity data all from a mobile device.

In general, the appliance extension according to embodiments described herein is designed and constructed to be a secure extension of a threat visualizer user interface of the cyber security appliance installed in the system with a limited set of functions including monitoring, investigating, and taking actions to counter the detected cyber threat, all of which an operator can securely take from the appliance extension; rather than, needing to log into the cyber security appliance and investigate potential cyber threats at a location where the cyber security appliance is installed in the system.

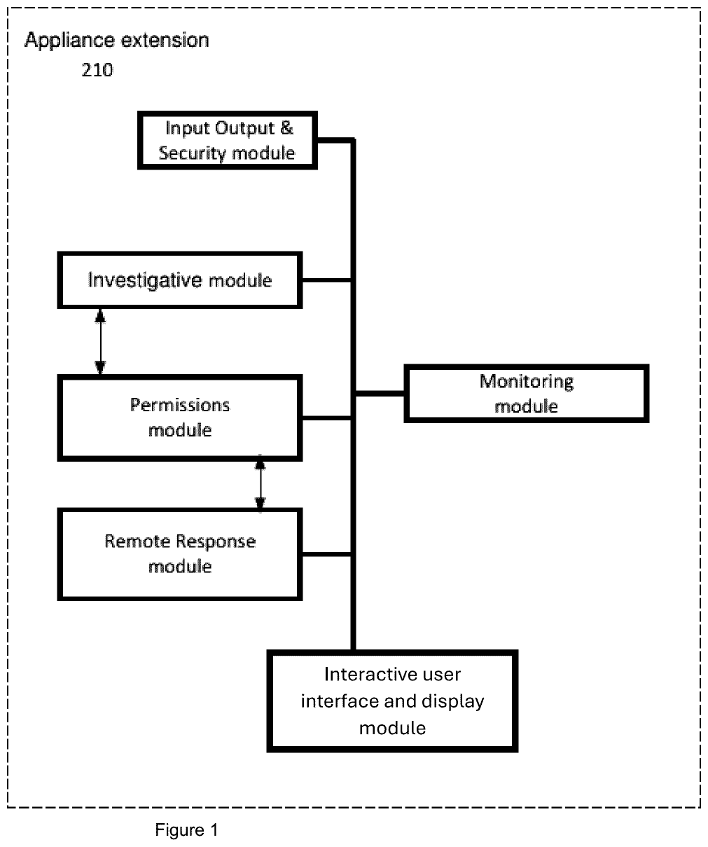

FIG. 1 illustrates a block diagram of an embodiment of an appliance extension with several different modules to perform various functions.

The appliance extension 210 can take form as an assembly, such as a collection of modules in a suitable mobile application resident on a smart mobile device and/or in a hand-held remote control. The appliance extension 210 can communicate remotely with a cyber security appliance/system located within an organization's virtual or physical network to at least monitor, investigate, and respond, to potential threats. The appliance extension 210 may also communicate with additional modules as discussed herein. The appliance extension 210 is designed to securely communicate with an externally facing backend server of a cyber security appliance protecting that network.

In an embodiment, a mobile application can be installed on a smart mobile device. Generally, registering an instance of the mobile application is restricted to authorized security professional within the organization.

The appliance extension 210 can perform at least three functions. The appliance extension 210 has a monitoring module configured to receive alerts regarding potential cyber threats on a system that includes an email system. In some embodiments, the system may additionally include but is not limited to, 1) a network, 2) a SaaS environment, 3) a cloud system, and 4) any combination of the network, the SaaS environment, and the cloud system together with the email system. The monitoring module is also configured to provide these metrics and alerts to the display module for visualization and interaction on the interactive user interface. The appliance extension 210 has an investigative module configured to receive relevant contextual metrics from a cybersecurity appliance and display these on the interactive user interface to support investigations on potential cyber threats. The appliance extension 210 has a remote response module configured to receive observations and one or more recommended actions from an autonomous response module and return one or more control signals back to the autonomous response module to take actions to counter one or more detected cyber threats, remotely from this appliance extension 210. The appliance extension is further configured to display the one or more recommended actions on the interactive user interface. The interactive user interface is configured to receive one or more user inputs from a user to control or modify the one or more actions. The appliance extension 210 is configured to provide a secure extension.

The appliance extension 210 has an interactive user interface to be displayed on a display screen. The user interface cooperates with the modules to display their relevant information on a display screen and to provide interactivity to a user for interacting with one or more aspects of the displayed metrics, alerts, and recommended actions. The appliance extension 210 has instructions associated with one or more of the modules stored in one or more memories and that are executed by one or more processors.

A battery can power the modules, memories, processors, display screen, and other components on the appliance extension 210.

The appliance extension 210 provides a simplified version of the threat visualizer user interface hosted on a cybersecurity appliance and allows a user from a mobile device to collaborate, communicate, and interact with that cyber security appliance installed in their network as well as the autonomous defense actions initiated by the cyber security appliance installed in their network, to restrain, counter, and/or contain threats quickly enough from their smart mobile device, such as a smart phone, a tablet, etc. The remote response module allows the approval or control of automatic defense actions initiated by the cyber threat defense system to restrain or contain threats, and the interactive user interface provides the user with the control over such actions from the appliance extension 210.

The cybersecurity appliance allows an individual with system administrator credentials to set up, per user, the privileges a user has whilst using the appliance extension. An administrator may authorize a particular user to register an instance of the mobile application with the server. The user must then register the instance of the app on their mobile device with the server.

The permissions may also include things like what functions that user can do with the investigative module and functions that the user can do with the remote response module, including how the user may interact through the interactive user interface.

The permissions can be set, per user, and be set by the administrator via the Account Permissions page in the cybersecurity appliance user interface. The permissions can be revoked at any time by the system administrator. When the administrator revokes the particular user's permission to use the appliance extension 210, then a communication is sent to the appliance extension 210 to cause deletions of data and instructions for the appliance extension 210 to occur, such as the model breach, actions taken, security information, and summary cached data within the appliance extension 210 is deleted for the given user.

The appliance extension 210 also allows a user to be promptly notified of in-progress cyber threats within an organization via a push notification sent from the appliance and routed to the device, via a server.

Overall, the appliance extension 210 is designed and constructed to be a secure extension of the threat visualizer user interface of the cyber security appliance installed in the system with a limited set of functions including at least the monitoring, the investigating, and the taking actions of to counter the detected cyber threat, all of which an operator can securely take from the appliance extension 210; rather than, needing to log into the cyber security appliance and investigate potential cyber threats at a location where the cyber security appliance is installed in the system.

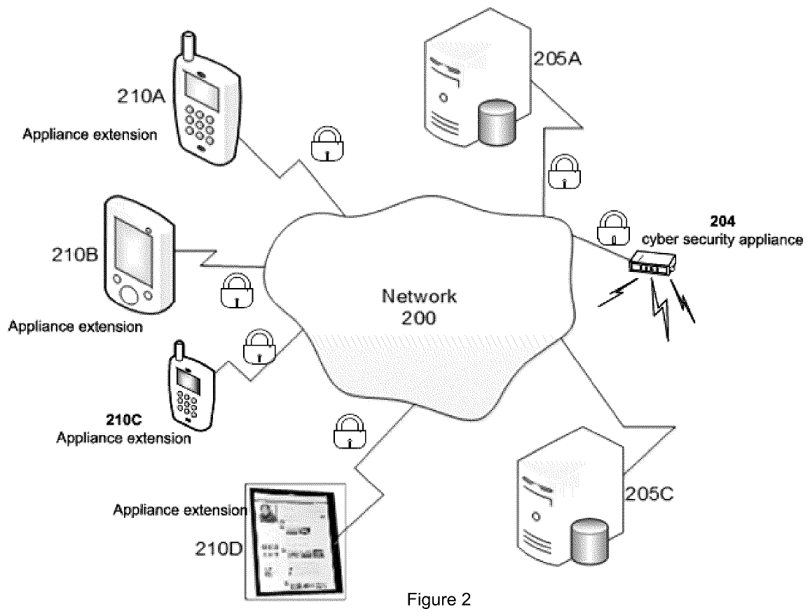

FIG. 2 illustrates a block diagram of an example appliance extension with instances of the mobile application resident on each mobile device to enable collaboration and communication with the cyber defense appliance installed in the system.

The appliance extension can be a mobile application installed on a smart mobile device, where the appliance extension is designed and constructed to be a secure extension of a threat visualizer user interface of the cyber security appliance installed in the system. Multiple appliance extensions 210A, 210C, and 210D, cooperate with a backend server 206A and a cyber security appliance 204.

The appliance extension can be a mobile application installed on any suitable smart mobile device 210A, 210C, and 210D (mobile applications on a smart phone or tablet) that needs to be registered. Likewise, the appliance extension can be a handheld remote control 210B that needs to be registered. As discussed, the appliance extension 210A-210D is designed and constructed to be a secure extension of a threat visualizer user interface of the cyber security appliance 204 installed in the system with a limited set of functions including at least the monitoring, the investigating, the taking actions to counter the detected cyber threat, and the user interactivity provided by the interactive user interface, all of which an operator can securely take from the appliance extension 210A-210D; rather than, needing to log into the cyber security appliance 204 and investigate potential cyber threats at a location where the cyber security appliance 204 is installed in the system.

A system administrator can authorize specific users in the organization that can download and register an instance of the mobile application with a backend server 205A that is cooperating with the cyber security appliance 204. The mobile application is available from an online app store, such as the Apple or Google store.

The appliance extension 210A-210D needs to initially register and authenticated to do anything. The appliance extension 210A-210D requires a user authentication with the backend service, which can be authorized by a system administrator via a configuration setting in the cyber security appliance 204 itself. Once the mobile application is downloaded, the appliance extension 210A-210D can start a registration process of that instance of the appliance extension 210A-210D by, for example, i) scanning a QR code (discussed later) or ii) another mechanism generated from within the threat visualizer user interface on the cyber security appliance 204. On the user interface of the appliance extension 210A-210D, navigating to a “Register Mobile App” popup window available from the “Account Settings” tab from the Main Menu of the user interface of the cybersecurity appliance 210A-210D.

In an embodiment, a user, identified as a user that can be a registered user, needs to log in with their account and password to the cybersecurity appliance in order to allow a subsequent pop up window on the cyber security appliance 204 to be available and authenticate the appliance extension with the backend server 205A. The appliance extension 210A-210D can authenticate with the back-end service using the user's account username and password. The back-end service will authenticate the username/password with the cyber security appliance 204 and authorize the appliance extension. Periodically, this authentication can be refreshed if desired for enhanced security. After registration and authentication of the appliance extension 210A-210D, the backend server will authorize communications between the registered appliance extension 210A-210D, and the cyber security appliances associated with that account. Note, each instance of the mobile application will be associated with a specific authorized user, who will be given their set of configurable permissions on the permissions page by the system administrator. The mobile application can also prompt the user to set up a PIN code or allow biometric authentication for subsequent local authentication.

Next, some additional preconditions must occur to allow a registration. In order to register instances of the appliance extension 210A-210D with one or more installed cyber security appliances, first, the threat visualizer user interface on the cyber security appliance 204 must be configured to be able to send alerts via a supported protocol. Alerts visible to the appliance extension 210A-210D through the back-end server can be filtered by the cybersecurity appliance based on user group access rights and other conditions. The cybersecurity appliance is configured to ensure an account exists for this system administrator and their supplied password and credentials are valid. The system administrator can authorize specific users in the organization that can register an instance of the mobile application with a backend server 205A that is cooperating with the cyber security appliance 204. Then one or more instances of mobile applications will be allowed to register, that instance of the mobile application, on their mobile device to the account in existence on the cybersecurity appliance via the backend server 205A.

In an embodiment, after the above example procedures, the mobile app is now downloaded, registered, authenticated, and resident on that user's smart mobile computing device, and subsequently run on that user's smart mobile computing device.

An instance of the appliance extension 210A-210D is required to be registered with a backend platform that is configured to communicate with the cyber security appliance 204. As discussed, the initial registration and authentication of its user and that instance of the appliance extension 210A-210D must occur. In addition, the instance of the appliance extension 210A-210D may be configured to permit use of a camera of the smart mobile device to scan a QR code generated from within the threat visualizer user interface of the cyber security appliance 204, which could be utilized to verify whether this instance of the appliance extension 210A-210D is allowed to communicate with the cyber security appliance 204 installed in the system.

In an example method of authentication between the appliance extension and the cybersecurity system, the camera of the smart mobile device or handheld remote control of that instance of the appliance extension 210A-210D captures an image of the displayed QR code from the user interface of the cyber security appliance 204 associated with this account. The QR code passes the required authentication information to allow the mobile app to communicate with the one or more cyber security appliances associated with this account. The scanning of the QR code and following along successful communication between the mobile application, the backend server 205A, via a secured protocol, and the cyber security appliance 204, then that instance of the appliance extension 210A-210D has completed its registration.

A registered instance of the appliance extension 210A-210D on the smart mobile device or handheld remote control, the backend server 205A, and the cyber security appliance 204 can communicate securely via at least using a secure protocol as well as a need to authenticate with a unique signature and/or individual user account credentials.

All communications are made via a secure socket protocol, such as Secure Sockets Layer (SSL), TLS, or HTTPS, to establish encrypted links between the on-line backend server 205A, the cyber security appliance 204 and each instance of the appliance extension 210A-210D. A registered and known instance of the appliance extension 210A-210D communicates directly with the backend server 205A and the backend server 205A communicates with the cyber security appliance 204. The backend server 205A, such as an IMAP server, can act as a middleman/proxy to insert extra degrees of separation between information communications from instances of the appliance extension 210A-210D and the one or more cyber security appliance 204 installed in the system. The cyber security appliance 204 exchanges information with the backend server 205A, via a secure socket protocol, to be routed to a known and registered instance of the appliance extension 210A-210D via a secure socket protocol between the appliance extension 210A-210D and the backend server 205A. Likewise, the known registered mobile application sends communications to the backend server 205A, via a secure socket protocol, to be routed, via another secure socket protocol to the cyber security appliance 204.

All data payload in the communications can themselves be encrypted from end to end and only an individually a registered instance of the appliance extension 210A-210D and the cyber security appliance 204 have been configured to decipher the encrypted data payload in the communications which also use the secure socket protocol. Thus, the monitoring module in an instance of the appliance extension 210A-210D is configured to receive data payload, such as the alerts, securely transmitted from the cyber security appliance 204, via using a security protocol as well as encrypting data itself being transmitted between the appliance extension 210A-210D and the cyber security appliance 204 installed in the system. The appliance extension 210A-210D has one or more cipher algorithms to decipher the encrypted data payload.

In addition, malicious individuals and malware are prevented from tapping into the communications and then sending a substitute communication via i) through a use of the secure encryption protocol for the exchanged messages as well as ii) through a use of one or more methods of identity verification associated with the communications between the cyber security appliance 204 and registered instances of the appliance extension 210A-210D.

Note, a back-end server with REST API can have benefits over an IMAP server. For example, delivery from the IMAP server can be slow without frequent polling, which is improved with the back-end server with the REST API. A limit to an amount of frequent polling can be restricted by a platform chosen as well as reducing frequent polling help to manage battery usage.

The backend server 205A can use push notifications for real time interactions. The back-end server can be deployable on a customer's premises or a suitable cloud service.

An instance of the example appliance extension 210A-210D is configured with a set of access permissions to the cyber security appliance 204 that specify definitions for Administration functions, Alert and Data Fetching functions, Collaboration functions, etc. Likewise, the access permissions for the cyber security appliance 204 can be made available in an instance of the appliance extension 210A-210D when it registers.

The registered mobile application on the smart device and the cyber security appliance 204 communicate via a backend server securely, via at least 1) using a secure protocol as well as 2) requiring a need to authenticate communications with unique identification verification such as a verifiable signature, not a public Internet Protocol IP address, from i) an instance of the registered mobile application, ii) the cyber security appliance installed in the system, or iii) unique signatures of both the cyber security appliance and the instance of the registered mobile application.

Thus, even if a malicious individual could break the secure socket protocol, the malicious individual would need to also duplicate the identity verification methods used in communications between the appliance extension 210A-210D and the cyber security appliance 204 via the backend server. The verifiable valid identity of the cyber security appliance 204 is capable of being verified/authenticated by the appliance extension 210A-210D.

Next, the appliance extension 210A-210D is configured to interact and display an integration of multiple organizational platforms, all monitorable and controllable from this single appliance extension 210A-210D. The appliance extension 210A-210D's agnostic nature of monitoring, displaying, and providing interaction with, for example, the model breaches on a first cyber security appliance installed in a network, a second cyber security appliance installed in a SaaS environment, a third cyber security appliance installed in a cloud environment, a fourth cyber security appliance installed in an email system, etc. on a same instance of the appliance extension 210A-210D. In the appliance extension 210A-210D malicious activity is all treated in the same way and produce the same kind of threat alert, including model breaches, meaning that the user will see threats from a vast range of platforms in one place and can tackle them equally and from a single location. An instance of the appliance extension 210A-210D registered with each of these cyber security appliances has the ability to monitor a huge distributed network across multiple layers from one centralized location remotely.

An instance of the appliance extension 210A-210D can improve the computing system. The appliance extension 210A-210D can be a mobile application located on a mobile device; and thus, avoids a user needing to power up and use a laptop or desktop computer to monitor the system.

The application installed on an endpoint device such as a smartphone includes the ability to review AI learning & responses towards emails, browse AI-based recommendations and control (including release) of these responses from a mobile device. The interactive user interface of the application extension can be interacted with to find out example things including but not limited to how the AI based system (discussed in more detail below) has responded to malicious emails, how and what it thinks of malicious emails, how and why it chose a specific autonomous response on a given email, etc. all from a user's device such as a smartphone. In addition, as will be described in more detail, the cyber security team can change the email protection system from the email app on the smartphone. The user can release an email held by the email protection system from the user interface of the app. The user can change the autonomous action that was performed on an email. The user can search for emails. The user can look at what the machine learning thought about a specific email communication, (e.g. why an email was flagged by the cybersecurity defense system), all from the mobile application (e.g. smartphone application).

The email user interface for the cyber security mobile application can be interacted with in many example ways in the manner described herein.

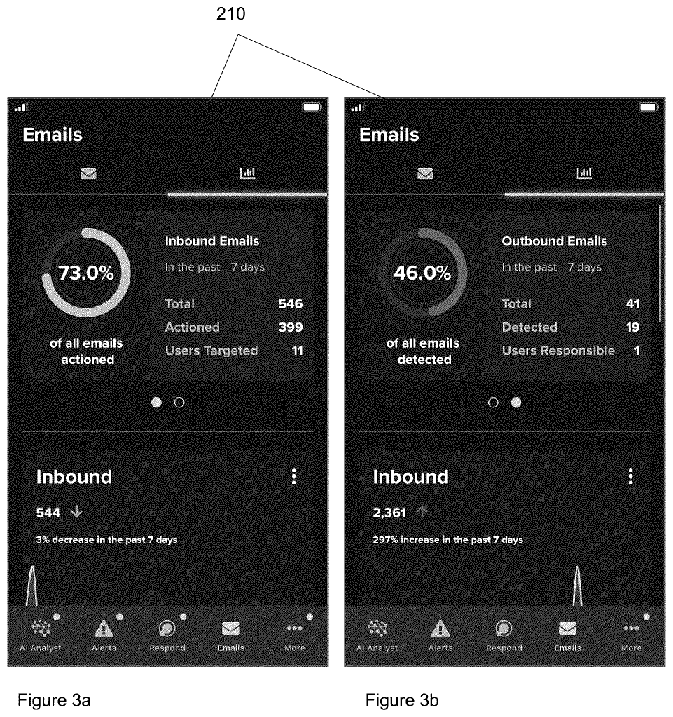

For example, FIGS. 3a and 3b illustrate diagrams of an example appliance extension for the email system with a monitoring module and an investigative module cooperating with the interactive user interface to retrieve and display metrics on potential cyber threats causing a model breach. The interactive user interface (or interactive email user interface) for the cyber security application can be interacted with to cause various actions through the dashboard. The appliance extension 210 includes, for example, multiple screens or displays including a dashboard screen. The dashboard screen provides high level information about a system including an email system, including metrics related to inbound and outbound emails. Through the interactive user interface, a user may interact with one or more metrics displayed on the dashboard screen. For example, a user may provide an input such as touch input to view additional information regarding inbound emails.

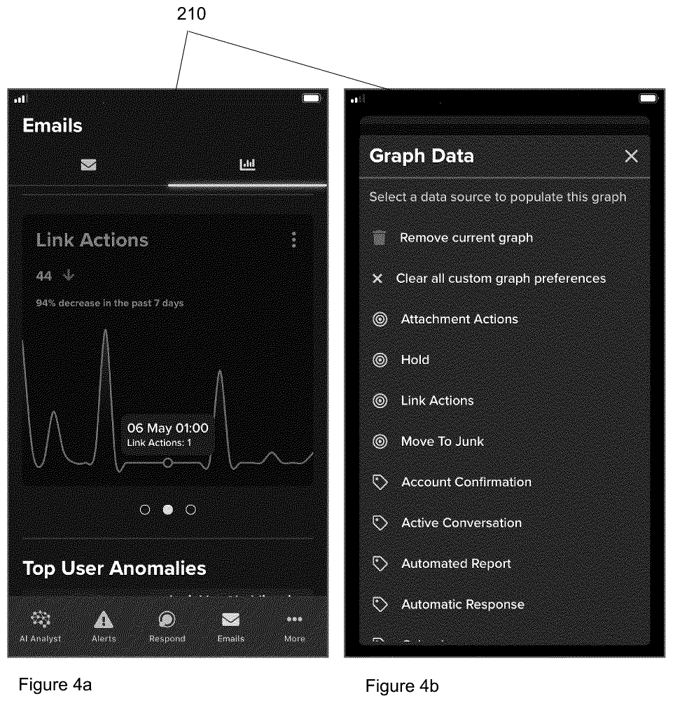

A user may also customize or modify the data shown on the dashboard screen. FIGS. 4a and 4b illustrate diagrams of an example appliance extension. FIG. 4a illustrates an example display of data in the form of a graph of link actions (how many autonomous actions has the autonomous response module taken on aspects of the email system in the past seven days). The content of the displayed graph may also be customized using the interactive user interface. FIG. 4b illustrates a customization screen in which, via the interactive user interface, a user may modify the content of the graph displayed by the interactive user interface if a user wishes to view different metadata regarding the email system. The user is provided with a plurality of options for which to produce graphs, and graphs may be provided for one or more of the displayed options. The graph data display of FIG. 4b may denote which actions have been taken by the cyber security system. For example, if one or more hold actions have been taken on the email system, a user may select the hold option and provide a graph for viewing how many hold actions have been taken, for example in the past seven days. A hold action may be an action in which an email is deemed anomalous by the cyber security system, and the email is removed from an email inbox and held in a buffer until it has been further triaged. At this stage, a user may choose to release an email, which may be via an interaction through the interactive user interface.

The graph data display of FIG. 4b may also denote tags, which may be grouped into categories of severity of behavior. For example, such groups may include critical, suspicious, and informational. Critical tags may result in relatively severe responses by the cyber security system such as by the autonomous response module. A suspicious tag may include behaviors deemed to be anomalous but not severe. Informational tags may include information on behaviors not deemed to be anomalous.

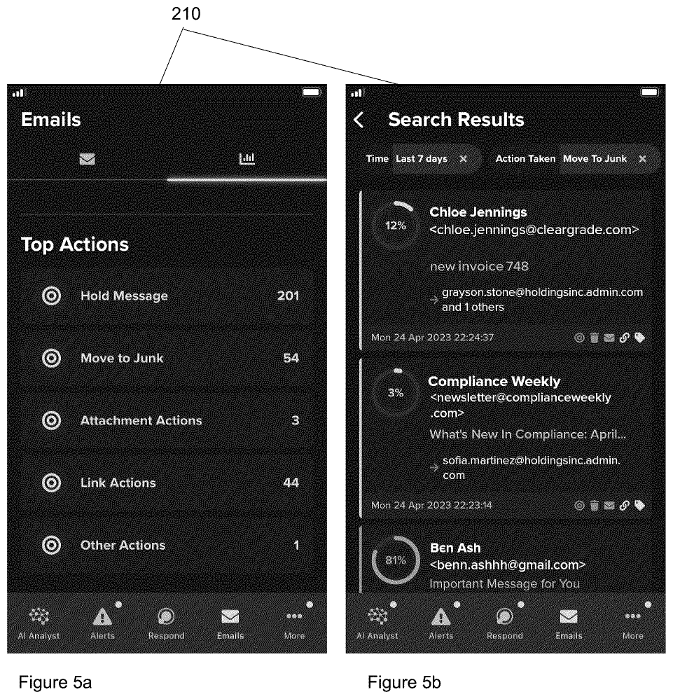

The appliance extension 210 may also be configured to display a summary of top actions taken on the email system over a particular time period, for example in the last seven days as illustrated in the diagram of FIG. 5a. A user may interact with each of the top actions via the interactive user interface of the appliance extension 210.

In this example, a user can see that fifty four emails have been moved to junk in the last seven days. A user then interacts with the interactive user interface to select the move to junk action and is shown a screen providing additional detail as in the diagram of FIG. 5b. The user is then conveniently shown all of the emails which have been moved to junk, showing information regarding each email including the sender, a subject line, and who received the email. Each email is also denoted with an anomaly score (discussed in more detail below). In addition, each email is provided with icons denoting information or actions taken. For example, a displayed email may include icons denoting one or more of: the email was actioned by the cyber security system, the email contains an attachment, the email has been given one or more tags, the email was never opened, or the email was moved to junk.

Conveniently, from the screen illustrated in FIG. 5b, a user may interact further with one or more emails via the interactive user interface. For example, a user may determine that an email is not malicious and may release a held email via a user input. Alternatively, a user may provide an input to control the cyber security system to take more severe action on the email or the email sender, such as hold the email completely.

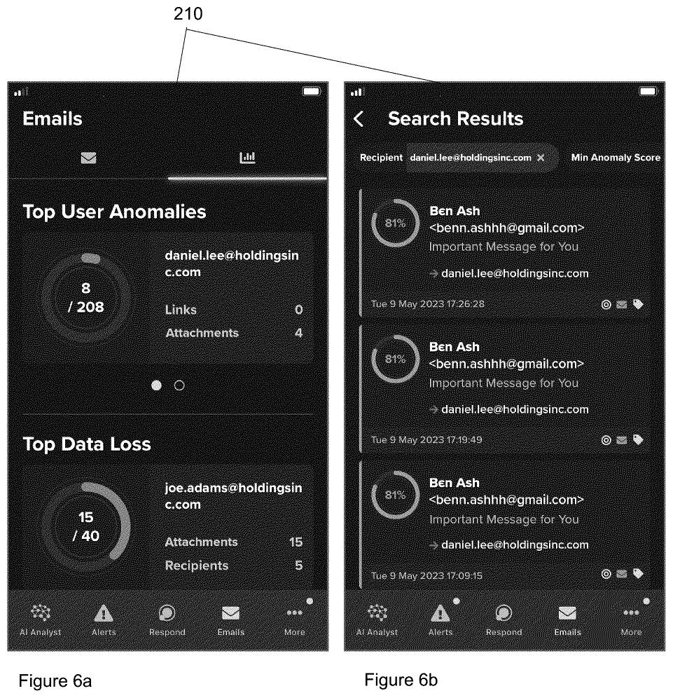

The appliance extension 210 may allow a user to view categories (FIG. 6a) of emails including, for example, top user anomalies or top data loss. Emails may have been categorized as such by the cyber security appliance in the manner described in more detail below. Following a user input from a user on the interactive user interface, the appliance extension 210 may display the emails within the selected category (FIG. 6b). Such emails are then displayed in an inbox-style view similar to that of FIG. 5b, and the user may interact similarly via the interactive user interface.

By providing the interaction through the appliance extension 210 on a user device, a user may conveniently action an email which may be held by the cyber security system. For example, if a user expects or is aware of an email that is known not to be malicious, but the cyber security system has deemed it malicious, a user may conveniently view and action the email in the manner described above to release the email from the user device.

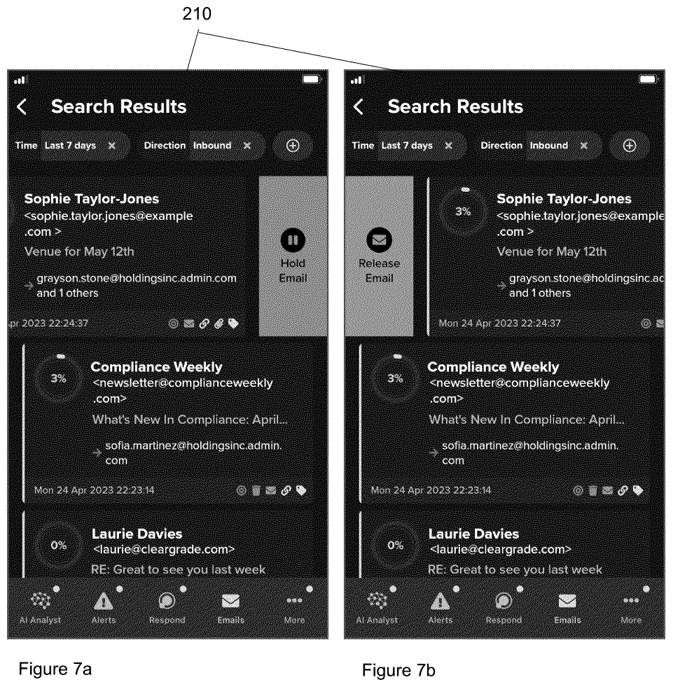

A user input through the user interface may include several forms of input. For example, FIGS. 7a and 7b illustrate slide gestures which may be input, for example, on a mobile device including a touch screen input. In FIG. 7a, a user is viewing inbound emails in the last seven days and may provide a slide input (such as a slide left input on a displayed email) to perform a hold action on an email. Alternatively, in FIG. 7b, an email which is held may be released through a slide input such as a slide right input on a displayed email.

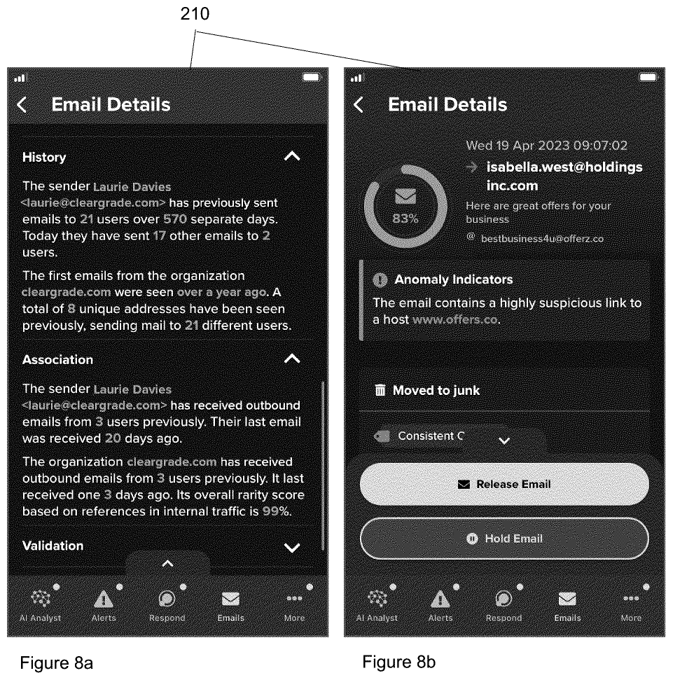

The appliance extension 210 may be configured to display an interactive contextualised summary of one or more of the metrics, alerts, and one or more actions on the interactive user interface in a simplified human-readable format based on a compilation of data from one or more of: the monitoring module, the investigative module, the remote response module, and additional data from the system. For example, FIG. 8a illustrates a display of the appliance extension 210 of details of an email. The details include an interactive contextualised summary including email details in a human-readable format. In particular, the contextualised summary includes details as to which the investigative module determines an email to be anomalous or suspicious. This provides a simplified, high level summary of the email details. Through the interactive user interface, a user may then take action on the email, or investigate further by viewing additional information following a user input.

This allows a user to conveniently assess an email based on the human-readable summary and take any further action necessary. For example, having reviewed the email details illustrated in FIG. 8a, a user may then take further action. FIG. 8b illustrates a diagram of a display of the appliance extension 210 in which a user can review an email moved to junk by the cyber security system, and having reviewed the contextualised summary, release the email if it is determined that the email is not malicious, or hold the email if it is determined that the email is or may be malicious.

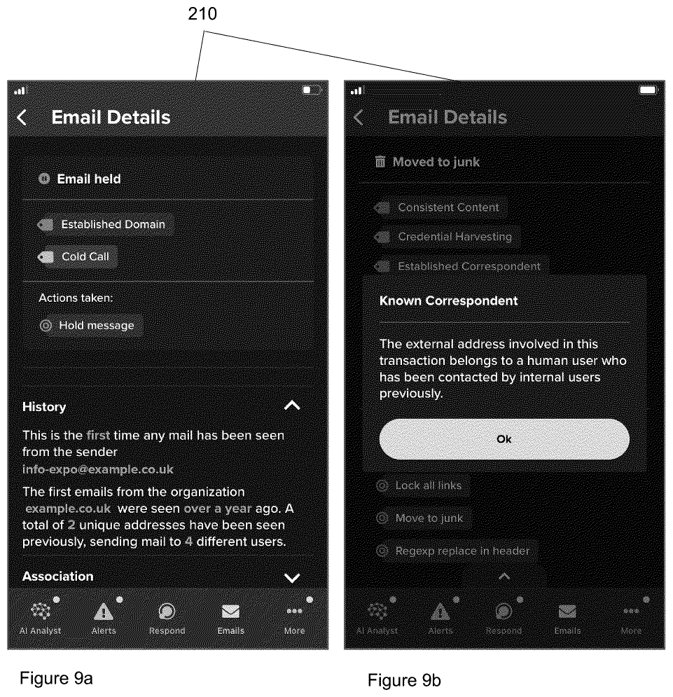

FIG. 9a illustrates another screen displayed by the appliance extension 210 displaying additional details related to an email. For example, similarly to FIG. 8a, an interactive contextualized human-readable summary is displayed. In addition, related tags are displayed denoting tags associated with the email provided by the cyber security system. In this example, the email is tagged as having an established domain and as potentially being a cold call. The colour of the tag may be indicative of the category discussed above, including informational, suspicious, or critical. The information displayed also includes the actions taken by the autonomous response module.

The appliance extension may be further configured to, in response to a user input, retrieve and display additional contextual information related to one or more of the metrics, the alerts, the one or more actions, or the detected cyber threat on the interactive user interface to allow the user to further investigate the detected cyber threats. In the example illustrated in FIG. 9b, following a user input, the appliance extension 210 displays additional contextual information including that the sender of the selected email is from a known correspondent. Again, this information is conveniently provided in a human-readable format. The interactive user interface may also be configured to receive comments input by the user, the comments being associated with one or more of the metrics, alerts, or one or more actions taken by the autonomous response module.

The interactive user interface is configured to receive one or more user inputs from a user to control or modify the one or more actions taken by the autonomous response module. The one or more user inputs to control or modify the one or more actions of the autonomous response module may comprise: approving one or more actions of the autonomous response module to counter the detected cyber threats; preventing the autonomous response module from performing the one or more actions; and modifying the one or more actions of the autonomous response module to counter the detected cyber threats.

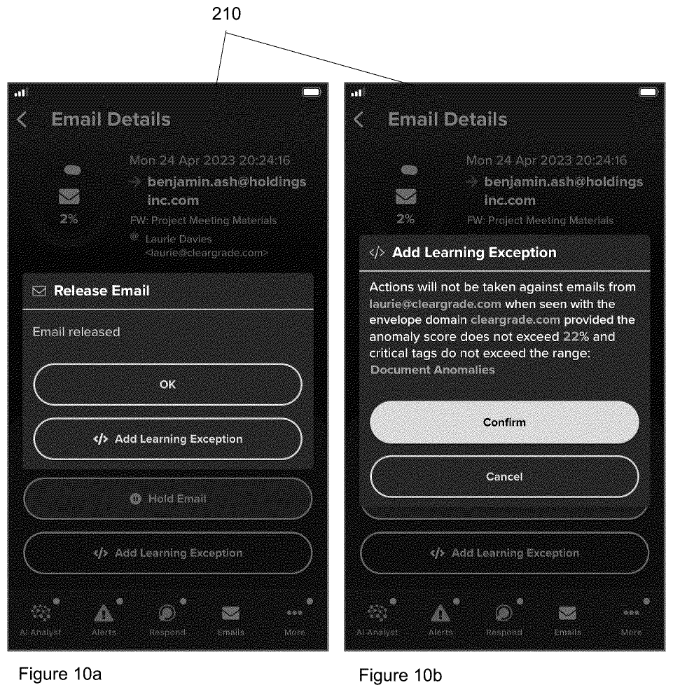

As discussed above, a user may provide a user input to release an email held by the cyber security system as illustrated in the example of FIG. 10a. In addition, the interactive user input allows user to control or modify the actions taken by the autonomous response module. In this example, a user has selected to release an email, at which stage the user may also provide a user input to add a learning exception. FIG. 10b illustrates such an example displayed by the appliance extension 210 in which a user has provided an input to modify the action taken by the autonomous response module. In this example, by adding the learning exception, the autonomous response module will no longer take actions against the relevant email subject to particular circumstances, which in this example include when the email is seen with the relevant envelope domain, a determined anomaly score is below a predetermined threshold, and critical tags do not exceed a predetermined range. The user is therefore provided with the capability to control or modify the actions of the autonomous response module from their mobile device via the appliance extension 210.

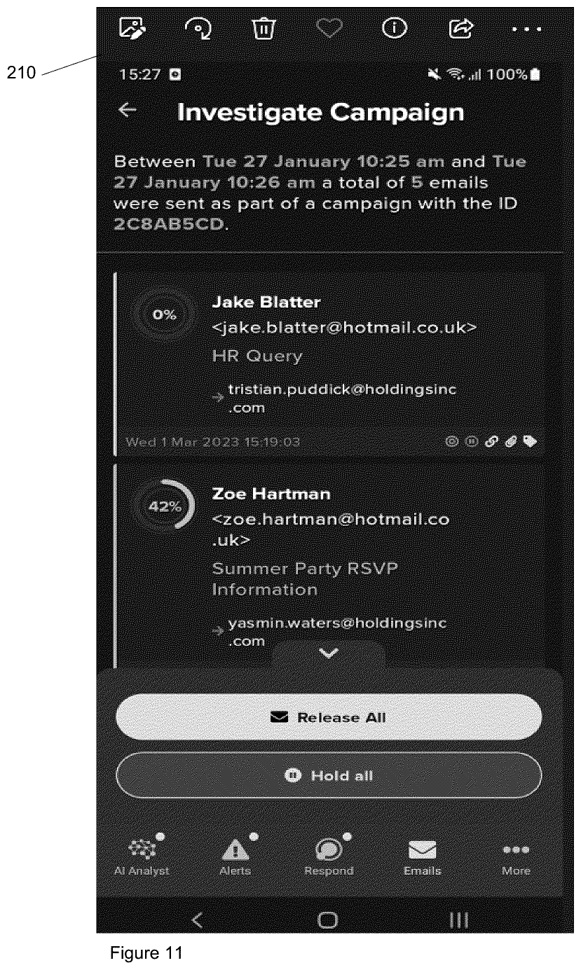

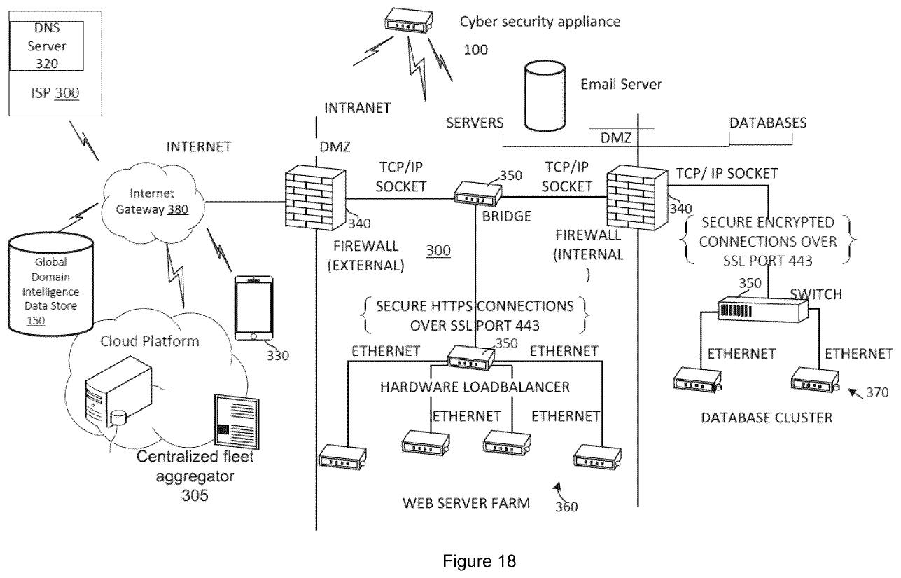

The email user interface for the cyber security application can be interacted with to view information on an email campaign. FIG. 11 illustrates an example appliance extension 210 displaying information related to an email campaign. This example again provides the user with contextual human-readable information, as well as the ability to interact and take action on the email campaign through the interactive user interface. The process for detecting an email campaign on an email system is described in more detail below with respect to FIG. 18.

The mobile application or appliance extension may also be configured to receive one or more notifications related to active cyber threats on one or more aspects of the system, or potential cyber threats on one or more aspects of the system.

For example, the appliance extension may be configured to receive a proactive threat notification (PTN) from an operator on the system, the PTN being indicative that a cyber threat has been detected on the system based on information from the monitoring module and the investigative module. The operator on the system may be an operator in a human Security Operations Center (SOC) team. The PTN may be sent to the application through the secure communications channel according to embodiments discussed herein, notifying a user that a cyber security incident is currently occurring on one or more aspects of the system. The PTN may then be displayed on the interactive user interface, which may include displaying information related to the potential cyber threat associated with the PTN together with a recommended action to counter the potential cyber threat.

For example, a notification may be received from a human SOC team communicating that it is believed that a user's system is currently under an active compromise, or based on a similar incident occurring with underlying similarities may become under an active compromise. Through the PTN, it is indicated that a user needs to log into the cyber security appliance, and through that secure communication channel with the backend cloud platform get additional information from the SOC team on why it is thought that the system has been compromised and the next set of actions you should take. Alternatively, the same information may be passed to the end user via the appliance or appliance extension and the secure communication channel between the mobile application and the cyber security appliance. The mobile application is already securely authenticated with the cyber security appliance and the cyber security appliance is securely authenticated with the backend cloud platform. Again, a secure tunnel is established through the mobile application which is also authenticated each time the secure tunnel is used. In this case, the end user can view the information on the mobile phone without having to necessarily log directly into the cyber security appliance which may require the user to have a desktop, which may be inconvenient if, for example, the notification is received late at night. In addition, the information is provided from the backend server through the secure channel onto the display screen of that end user's phone, meaning other applications and devices that maybe already compromised by a potentially ongoing cyber-attack are bypassed.

Having received one or more recommended actions in the PTN, the interactive user interface may receive one or more user inputs to approve, prevent, or modify the recommended action. The appliance is then configured to send one or more control signals to control the autonomous response module to perform the recommended action, perform the modified recommended action, or prevent performance of the recommended action.

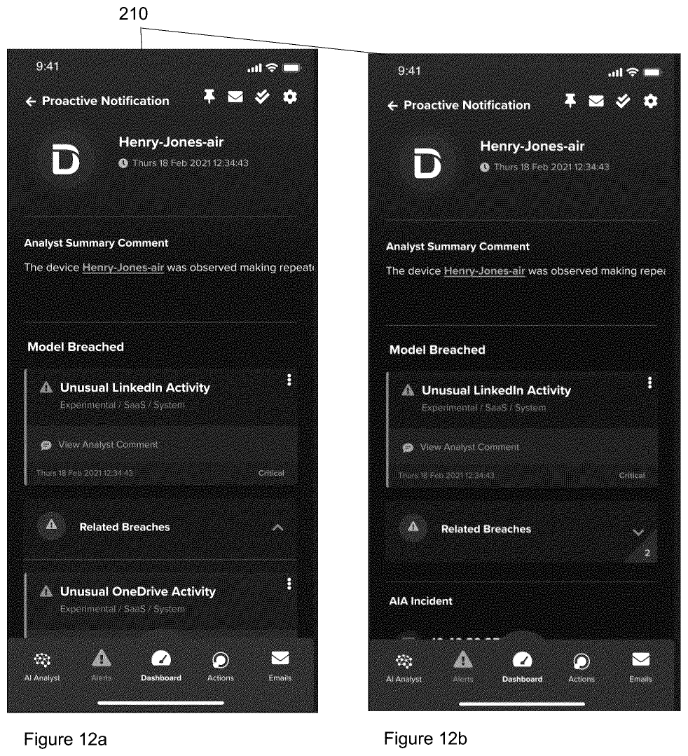

FIGS. 12a and 12b illustrate a diagram of an example PTN displayed on a user device through the appliance extension. As discussed, the user is provided with a summary from a human SOC member (Analyst Summary Comment) providing a human-readable overview of the detected cyber incident. The user is then provided with additional information related to the model breach and may provide user inputs to investigate the model breach further. The user may also input comments which are provided to the human SOC team who can review and provide further comments for viewing by the user through the mobile application. The PTNs may be provided based on one of more of the Artificial Intelligence modules (discussed more below) providing an alert of a model breach. The PTNs may be provided by a human operator within a short time period of a detected model breach, for example within fifteen minutes of the model breach being detected. The PTNs therefore provide a secure communication channel for the human SOC team to correspond with a user of the system efficiently, securely, and conveniently. This may be, for example, more secure than contacting a user through an email system which itself may be compromised by the model breach, thereby allowing sensitive information to be provided securely. The PTN may also be beneficial as a user may be aware of the activity deemed anomalous by the system, but the user may have expected the activity. Therefore, the user can prevent the autonomous response module from taking action against the detected cyber threat.

An example format of the PTN may be as follows:
[PTN] Darktrace SOC Alert—Attention Required
SOC Alert sent to: [zz@test.com]

The Darktrace SOC has triaged a high scoring alert for your organization. After further manual analysis, Darktrace recommend urgent follow-up work by your own IT team. The model alert inside the platform has had Analyst commentary on why they believe it is suspicious. Please log in to Darktrace (dt-1234-01) for further details.

All timestamps displayed are given in UTC.
Model: [ICS:Anomaly Then New ICS Commands] was breached at [2024-03-26 11:46:03]
Devices Breached:
/#device/57
Analyst Comments:
[Model Breach: ICS/Anomaly Then New ICS Commands 100%—Breach URI: /#modelbreach/2487848]
[Model Breach: ICS/Uncommon ICS Reprogram 79%—Breach URI: /#modelbreach/2487847]

The device 10.0.1.2 was observed making multiple OT reprogram requests to ICS_LAB_BACNET_DEVICE_41 SN:SN2020 . . . .

This behavior did not match the previous pattern of requests observed from this device. Consequently, though this activity could be due to a legitimate change in behavior, it could also be a sign of this device attempting to compromise or gather information on another OT endpoint in the network.

The security team may therefore wish to investigate these requests, and ensure they were expected.

### Breach Details:

Time of breach: 2024.03.26, 11:46:03 UTC
Breach device: 10.0.1.3
Breach device type: icsworkstation

### Summary of Reprogram Requests:

Time: 2024-03-26 11:46:01 UTC
Destination endpoint: ICS_LAB_BACNET_DEVICE_41 SN:SN#PFC11234-10.0.1.2
Destination port: 47808
Application protocol: BACNET
Number of requests: 3
Messages include:
   Device(2): restorePreparationTime(341)
   Device(2): serialNumber(372)
   Device(2): modelName(70)
Suspicious Properties: Device does not usually make requests of this type.

Alternatively or in addition, notifications may be provided to the mobile application of active new Common Vulnerabilities and Exposures (CVEs) that are emerging based upon like chatter in open-source intelligence, and/or chatter on social media, and then, if possible, notify the user what assets are impacted to the mobile application. The monitoring module and investigative module may be further configured to respectively monitor and retrieve additional metrics based at least in part on one or more of: third-party data and open source intelligence to identify potential cyber threats. The appliance extension may then be configured to receive a common vulnerabilities and exposures (CVE) notification from the investigative module based on the additional metrics, the CVE being indicative that a potential cyber threat putting the system at risk has been identified. The CVE notification may comprise information indicating one or more assets on the system which are at risk from the potential cyber threat. Based on the CVE, the mobile application may be configured to receive one or more recommended actions, which may be actions for the autonomous response module, to prevent the cyber threat from developing. The user may confirm, prevent, or modify such actions from the mobile application through the interactive user interface.

For example, the cyber security system may detect several serious high level model breaches and analysts suggest that these may amount to critical incidents. Those incidents are escalated to a human SoC team member who then performs a human investigation and provides a summary of what they think. The human investigation and write up of what they think the problem is can be delivered within, for example, 15 minutes of the alert. In addition, a PTN can also then be sent to the user's mobile application if the emerging cyber threat becomes an active model breach on the system.

In an example, as those active new Common Vulnerabilities and Exposures are confirmed by analyst teams, or by another form of validation, then the system sends alerts to that particular user through their mobile device which conveys that an emerging 0 day cyber threat has been identified and the user's network is at risk. In addition, the assets on the network that are affected are identified based upon the human analysts knowledge of the asset inventory of the network environment. For example, the human analyst may know that these assets are running a particular software, and it is believed that there is an emerging 0 day cyber threat associated with the software.

Therefore, two forms of notification may be provided which may be proactive (detected through machine learning analysis before a cyber threat affects a system) or reactive (provided by a human operator after a model breach has occurred on the system and the system is under active compromise). These notifications may be provided sequentially as a cyber threat develops.

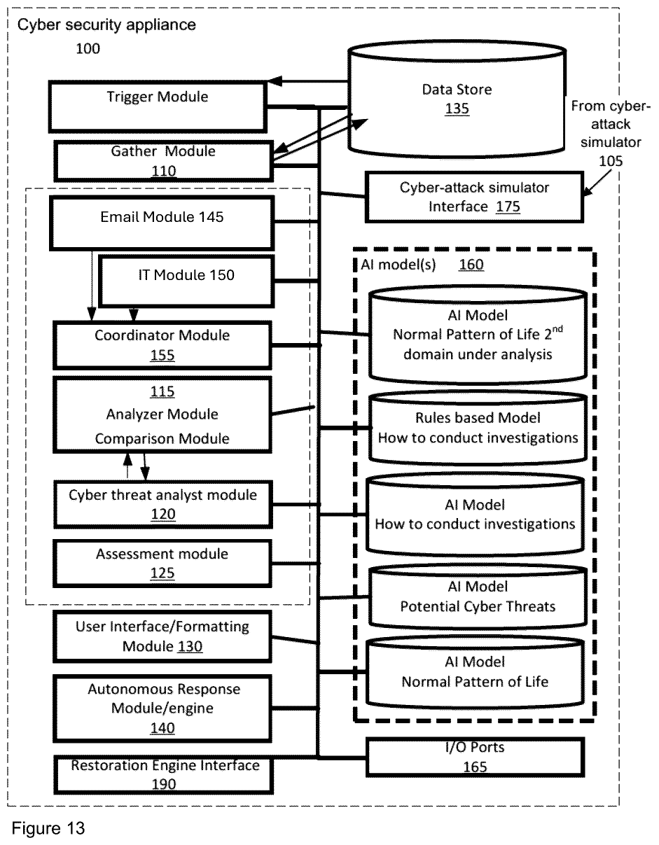

FIG. 13 illustrates a block diagram of an embodiment of the AI-based cyber security appliance with example components making up a detection engine that protects a system, including but not limited to a network/domain, from cyber threats. The monitoring module and the investigative module may perform functions with one or more components of the detection engine. The mobile application and appliance extension may perform functions together with one or more of the modules or aspects of the cyber security appliance as described herein. Various Artificial Intelligence models and modules of the cyber security appliance 100 or cyber security defense system cooperate to protect a system, such as one or more networks/domains under analysis, from cyber threats. As shown, according to one embodiment of the disclosure, the AI-based cyber security appliance 100 may include a trigger module, a gather module 110, an analyzer module 115, a cyber threat analyst module 120, an assessment module 125, a user interface and formatting module 130, a data store 135, an autonomous response engine 140 and/or an interface to an autonomous response engine 140, a first (1^{st}) domain module (which in this example is an email module 145), a second (2^{nd}) domain module (which in this example is an IT module 150), and a coordinator module 155, one or more AI models 160 (hereinafter, AI model(s)”), and/or other modules. The AI model(s) 160 may be trained with machine learning on a normal pattern of life for entities in the network(s)/domain(s) under analysis, with machine learning on cyber threat hypotheses to form and investigate a cyber threat hypothesis on what are a possible set of cyber threats and their characteristics, symptoms, remediations, etc., and/or trained on possible cyber threats including their characteristics and symptoms, an interface to a restoration engine 190, an interface to a cyber-attack simulator 105, and other similar components.

The first domain module 145 is, in this example, an email module configured to receive information from and send information to, in this example, email-based sensors (i.e., probes, taps, etc.). The email module 145 also has algorithms and components configured to understand, in this example, email parameters, email protocols and formats, email activity, and other email characteristics of the network under analysis. The second domain module 150 may operate as an IT network module configured to receive information from and send information to, in this example, IT network-based sensors (i.e., probes, taps, etc.). The second domain module 150 also has algorithms and components configured to understand, in this example, IT network parameters, IT network protocols, IT network activity, and other IT network characteristics of the network under analysis. Additional domain modules can also collect domain data from another respective domain.

The cyber security appliance 100 can host the cyber threat detection engine and other components. The cyber security appliance 100 includes a set of modules cooperating with one or more Artificial Intelligence models configured to perform a machine-learned task of detecting a cyber threat incident. The detection engine uses the set of modules cooperating with the one or more Artificial Intelligence models to detect anomalous behavior of one or more nodes, including at least user accounts, devices, and versions of source code files, in a graph of a system being protected. The detection engine uses the set of modules cooperating with the one or more Artificial Intelligence models in the cyber security appliance 100 to prevent a cyber threat from compromising the nodes and/or spreading through the nodes of the system.

The cyber security appliance 100 with the Artificial Intelligence (AI)-based cyber security system may protect a network/domain from a cyber threat (insider attack, malicious files, malicious emails, etc.). In an embodiment, the cyber security appliance 100 can protect all of the devices on the network(s)/domain(s) being monitored by monitoring domain activity including communications). For example, an IT network domain module 150 may communicate with network sensors to monitor network traffic going to and from the computing devices on the network as well as receive secure communications from software agents embedded in host computing devices/containers. The steps below will detail the activities and functions of several of the components in the cyber security appliance 100.

The gather module 110 may be configured with one or more process identifier classifiers. Each process identifier classifier may be configured to identify and track one or more processes and/or devices in the network, under analysis, making communication connections. The data store 135 cooperates with the process identifier classifier to collect and maintain historical data of processes and their connections, which is updated over time as the network is in operation. Individual processes may be present in merely one or more domains being monitored. In an example, the process identifier classifier can identify each process running on a given device along with its endpoint connections, which are stored in the data store 135. In addition, a feature classifier can examine and determine features in the data being analyzed into different categories.

The analyzer module 115 can cooperate with the AI model(s) 160 or other modules in the cyber security appliance 100 to confirm a presence of a cyberattack against one or more domains including an email module in an enterprise's system. A process identifier in the analyzer module 115 can cooperate with the gather module 110 to collect any additional data and metrics to support a possible cyber threat hypothesis. Similarly, the cyber threat analyst module 120 can cooperate with the internal data sources as well as external data sources to collect data in its investigation. More specifically, the cyber threat analyst module 120 can cooperate with the other modules and the AI model(s) 160 in the cyber security appliance 100 to conduct a long-term investigation and/or a more in-depth investigation of potential and emerging cyber threats directed to one or more domains in an enterprise's system. Herein, the cyber threat analyst module 120 and/or the analyzer module 115 can also monitor for other anomalies, such as model breaches, including, for example, deviations for a normal behavior of an entity, and other techniques discussed herein. As an illustrative example, the analyzer module 115 and/or the cyber threat analyst module 120 can cooperate with the AI model(s) 160 trained on potential cyber threats in order to assist in examining and factoring these additional data points that have occurred over a given timeframe to see if a correlation exists between 1) a series of two or more anomalies occurring within that time frame and 2) possible known and unknown cyber threats. The cyber threat analyst module can cooperate with the internal data sources as well as external data sources to collect data in its investigation.

According to one embodiment of the disclosure, the cyber threat analyst module 120 allows two levels of investigations of a cyber threat that may suggest a potential impending cyberattack. In a first level of investigation, the analyzer module 115 and AI model(s) 160 can rapidly detect and then the autonomous response engine 140 will autonomously respond to overt and obvious cyberattacks. However, thousands to millions of low level anomalies occur in a domain such as an email module under analysis all of the time; and thus, most other systems need to set the threshold of trying to detect a cyberattack by a cyber threat at level higher than the low level anomalies examined by the cyber threat analyst module 120 just to not have too many false positive indications of a cyberattack when one is not actually occurring, as well as to not overwhelm a human cyber security analyst receiving the alerts with so many notifications of low level anomalies that they just start tuning out those alerts. However, advanced persistent threats attempt to avoid detection by making these low-level anomalies in the system over time during their cyberattack before making their final coup de grace/ultimate mortal blow against the system (e.g., domain such as an email module) being protected. The cyber threat analyst module 120 also conducts a second level of investigation over time with the assistance of the AI model(s) 160 trained with machine learning on how to form cyber threat hypotheses and how to conduct investigations for a cyber threat hypothesis that can detect these advanced persistent cyber threats actively trying to avoid detection by looking at one or more of these low-level anomalies as a part of a chain of linked information.

Note, a data analysis process can be algorithms/scripts written by humans to perform their function discussed herein; and can in various cases use AI classifiers as part of their operation. The cyber threat analyst module 120 forms in conjunction with the AI model(s) 160 trained with machine learning on how to form cyber threat hypotheses and how to conduct investigations for a cyber threat hypothesis investigate hypotheses on what are a possible set of cyber threats. The cyber threat analyst module 120 can also cooperate with the analyzer module 115 with its one or more data analysis processes to conduct an investigation on a possible set of cyber threats hypotheses that would include an anomaly of at least one of i) the abnormal behavior, ii) the suspicious activity, and iii) any combination of both, identified through cooperation with, for example, the AI model(s) 160 trained with machine learning on the normal pattern of life of entities in the system. For example, the cyber threat analyst module 120 may perform several additional rounds of gathering additional information, including abnormal behavior, over a period of time, in this example, examining data over a 7-day period to determine causal links between the information. The cyber threat analyst module 120 may submit to check and recheck various combinations/a chain of potentially related information, including abnormal behavior of a device/user account under analysis for example, until each of the one or more hypotheses on potential cyber threats are one of 1) refuted, 2) supported, or 3) included in a report that includes details of activities assessed to be relevant activities to the anomaly of interest to the user and that also conveys at least this particular hypothesis was neither supported or refuted. For this embodiment, a human cyber security analyst is needed to further investigate the anomaly (and/or anomalies) of interest included in the chain of potentially related information.

An input from the cyber threat analyst module 120 of a supported hypothesis of a potential cyber threat will trigger the analyzer module 115 to compare, confirm, and send a signal to act upon and mitigate that cyber threat. In contrast, the cyber threat analyst module 120 investigates subtle indicators and/or initially seemingly isolated unusual or suspicious activity such as a worker is logging in after their normal working hours or a simple system misconfiguration has occurred. Most of the investigations conducted by the cyber threat analyst module 120 cooperating with the AI model(s) 160 trained with machine learning on how to form cyber threat hypotheses and how to conduct investigations for a cyber threat hypothesis on unusual or suspicious activities/behavior may not result in a cyber threat hypothesis that is supported but rather most are refuted or simply not supported. Typically, during the investigations, several rounds of data gathering to support or refute the long list of potential cyber threat hypotheses formed by the cyber threat analyst module 120 will occur before the algorithms in the cyber threat analyst module 120 will determine whether a particular cyber threat hypothesis is supported, refuted, or needs further investigation by a human. The rounds of data gathering may build chains of linked low-level indicators of unusual activity along with potential activities that could be within a normal pattern of life for that entity to evaluate the whole chain of activities to support or refute each potential cyber threat hypothesis formed. (See again, for example, FIG. 13 and a chain of linked low-level indicators, including abnormal behavior compared to the normal pattern of life for that entity, all under a score of 50 on a threat indicator score). The investigations by the cyber threat analyst module 120 can happen over a relatively long period of time and be far more in depth than the analyzer module 115 which will work with the other modules and AI model(s) 160 to confirm that a cyber threat has in fact been detected.

The gather module 110 may further extract data from the data store 135 at the request of the cyber threat analyst module 120 and/or analyzer module 115 on each possible hypothetical threat that would include the abnormal behavior or suspicious activity and then can assist to filter that collection of data down to relevant points of data to either 1) support or 2) refute each particular hypothesis of what the cyber threat, the suspicious activity and/or abnormal behavior relates to. The gather module 110 cooperates with the cyber threat analyst module 120 and/or analyzer module 115 to collect data to support or to refute each of the one or more possible cyber threat hypotheses that could include this abnormal behavior or suspicious activity by cooperating with one or more of the cyber threat hypotheses mechanisms to form and investigate hypotheses on what are a possible set of cyber threats.

Thus, the cyber threat analyst module 120 is configured to cooperate with the AI model(s) 160 trained with machine learning on how to form cyber threat hypotheses and how to conduct investigations for a cyber threat hypothesis to form and investigate hypotheses on what are a possible set of cyber threats and then can cooperate with the analyzer module 115 with the one or more data analysis processes to confirm the results of the investigation on the possible set of cyber threats hypotheses that would include the at least one of i) the abnormal behavior, ii) the suspicious activity, and iii) any combination of both, identified through cooperation with the AI model(s) 160 trained with machine learning on the normal pattern of life/normal behavior of entities in the domains under analysis.

Note, in the first level of threat detection, the gather module 110 and the analyzer module 115 cooperate to supply any data and/or metrics requested by the analyzer module 115 cooperating with the AI model(s) 160 trained on possible cyber threats to support or rebut each possible type of cyber threat. Again, the analyzer module 115 can cooperate with the AI model(s) 160 and/or other modules to rapidly detect and then cooperate with the autonomous response engine 140 to autonomously respond to overt and obvious cyberattacks, (including ones found to be supported by the cyber threat analyst module 120).

As a starting point, the AI-based cyber security appliance 100 can use multiple modules, each capable of identifying abnormal behavior and/or suspicious activity against the AI model(s) 160 trained on a normal pattern of life for the entities in the network/domain under analysis, which is supplied to the analyzer module 115 and/or the cyber threat analyst module 120. The analyzer module 115 and/or the cyber threat analyst module 120 may also receive other inputs such as AI model breaches, AI classifier breaches, etc. a trigger to start an investigation from an external source.

Many other model breaches of the AI model(s) 160 trained with machine learning on the normal behavior of the system can send an input into the cyber threat analyst module 120 and/or the trigger module to trigger an investigation to start the formation of one or more hypotheses on what are a possible set of cyber threats that could include the initially identified abnormal behavior and/or suspicious activity. Note, a deeper analysis can look at example factors such as i) how long has the endpoint existed or is registered; ii) what kind of certificate is the communication using; iii) is the endpoint on a known good domain or known bad domain or an unknown domain, and if unknown what other information exists such as registrant's name and/or country; iv) how rare; v), etc.

Note, the cyber threat analyst module 120 cooperating with the AI model(s) 160 trained with machine learning on how to form cyber threat hypotheses and how to conduct investigations for a cyber threat hypothesis in the AI-based cyber security appliance 100 provides an advantage as it reduces the time taken for human led or cyber security investigations, provides an alternative to manpower for small organizations and improves detection (and remediation) capabilities within the cyber security appliance 100.

The cyber threat analyst module 120, which forms and investigates hypotheses on what are the possible set of cyber threats, can use hypotheses mechanisms including any of 1) one or more of the AI model(s) 160 trained on how human cyber security analysts form cyber threat hypotheses and how to conduct investigations for a cyber threat hypothesis that would include at least an anomaly of interest, 2) one or more scripts outlining how to conduct an investigation on a possible set of cyber threats hypotheses that would include at least the anomaly of interest, 3) one or more rules-based models on how to conduct an investigation on a possible set of cyber threats hypotheses and how to form a possible set of cyber threats hypotheses that would include at least the anomaly of interest, and 4) any combination of these. Again, the AI model(s) 160 trained on ‘how to form cyber threat hypotheses and how to conduct investigations for a cyber threat hypothesis’ may use supervised machine learning on human-led cyber threat investigations and then steps, data, metrics, and metadata on how to support or to refute a plurality of the possible cyber threat hypotheses, and then the scripts and rules-based models will include the steps, data, metrics, and metadata on how to support or to refute the plurality of the possible cyber threat hypotheses. The cyber threat analyst module 120 and/or the analyzer module 115 can feed the cyber threat details to the assessment module 125 to generate a threat risk score that indicate a level of severity of the cyber threat.

The multiple Artificial Intelligence-based engines each have an interface to communicate with the other separate Artificial Intelligence-based engines. Each Intelligence-based engine has an interface to communicate with another separate Artificial Intelligence-based engine, which is configured to understand a type of information and communication that this other separate Artificial Intelligence-based engine needs to make determinations on an ongoing cyberattack from that other Artificial Intelligence-based engine's perspective. The autonomous response engine 140 works with the assessment module in the detection engine when the cyber threat is detected and autonomously takes one or more actions to mitigate the cyber threat. FIG. 13 shows the example components making up the detection engine to include interfaces to the cyber-attack simulator, the autonomous response engine 140, and the restoration engine.

The cyber threat detection engine can also have an anomaly alert system in a formatting module configured to report out anomalous incidents and events as well as the cyber threat detected to a display screen viewable by a human cyber-security professional. Each Artificial Intelligence-based engine has a rapid messaging system to communicate with a human cyber-security team to keep the human cyber-security team informed on actions autonomously taken and actions needing human approval to be taken.

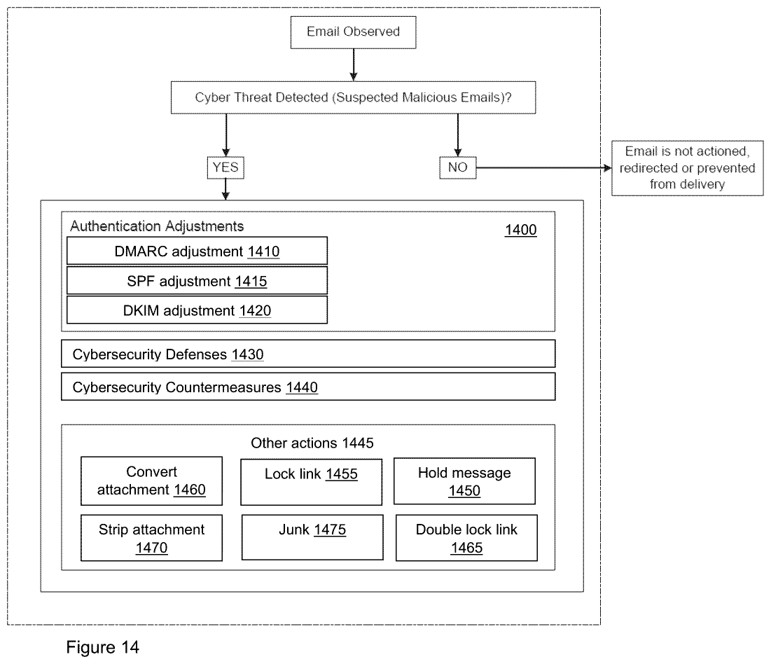

FIG. 14 illustrates a block diagram of an embodiment of example autonomous actions automatically conducted by the autonomous response module 140 of FIG. 13 without a human initiating that action is shown. The autonomous response module 140 is configurable, via a user interface of one or both of the cyber security appliance or appliance extension 210, to know when it should take the autonomous actions to contain a cyber threat when malicious activity is determined, for example on the email system, by the email module 145 or the cyber threat analyst module 120. According to one embodiment, the autonomous response module 140 operates as an administrative tool, configurable through the user interface of one or both of the cyber security appliance or appliance extension 210, to program/set what autonomous actions are to perform in response to signaling from the email module 145 or the cyber threat analyst module 120.

The following selection of example actions to be performed in response to the email module 145 receiving the DMARC reports, which identifies a third-party service is falsely representing itself as a user or a member of an organization associated with the monitored domain or authorized to operate on behalf of the user or organization for email communications. These actions may be categorized into authentication adjustment 1400, cyber security defensive actions 1430, and/or cyber security countermeasures 1440.

More specifically, the authentication adjustment 1400 may include DMARC authentication adjustment 1410, SPF authentication adjustment 1415, and/or DKIM authentication adjustment 1420. For DMARC authentication adjustment 1410, the autonomous response module 140 may cause the cyber security appliance 100 to alter the published DMARC record pertaining to the monitored domain. The alteration may involve changing a tag value that selects the DMARC policy in email servers handling emails that fail the DMARC authentication. For example, the alteration may change from no action (“none” policy) to a more aggressive action (“reject” or “quarantine”). Also, the frequency of the conveyance of the DMARC aggregate report may be changed to increase the reporting time from daily to multiple times per day so that the domain administrator can monitor the current threat landscape more closely.

For SPF authentication adjustment 1415, the autonomous response module 140 may cause the cyber security appliance 100 to alter the SPF record pertaining to the monitored domain. The alteration may involve adding or removing an authorized server from its listing. Such changes may be temporary to effectively disable usage of an authorized server that may be compromised by a malicious actor. Similarly, for DKIM authentication adjustment 1420, the autonomous response module 140 may cause the cyber security appliance 100 to alter the DKIM record pertaining to the monitored domain.

The cyber security defensive actions 1430 may include actions to fortify cyber security defenses of computing devices associated with the network system associated with the monitored domain. The cyber security countermeasures 1440 may include actions that are directed to neutralize operability of identified malicious servers as described above. These actions may be similar to the actions by the autonomous response module 140 in response to signaling from the cyber threat analyst module 125 or the email module 145.

Other exemplary actions based on signaling from the cyber threat analyst module 125 or the email module 145 may be categorized into delivery actions, attachment actions, link actions, header, and body actions, etc., which appear on the dashboard and can be taken by or at least suggested to be taken by the autonomous response module 140 when the threat risk parameter is equal to or above a configurable set point set by a domain administrator. Examples of these other actions 1445 are described below.

Hold Message 1450: The autonomous response module 140 has held the message before delivery due to suspicious content or attachments. Held emails can be reprocessed and released by an operator after investigation. The email will be prevented from delivery, or if delivery has already been performed, removed from the recipient's inbox. The original mail will be maintained in a buffered cache by the data store and can be recovered, or sent to an alternative mailbox, using the ‘release’ button in the user interface.

Lock Links 1455: The autonomous response module 140 replaces the URL of a link such that a click of that link will first divert the user via an alternative destination. The alternative destination may optionally request confirmation from the user before proceeding. The original link destination and original source will be subject to additional checks before the user is permitted to access the source.

Convert Attachment 1460: The autonomous response module 140 converts one or more attachments of this email to a safe format, flattening the file typically by converting into a PDF through initial image conversion. This delivers the content of the attachment to the intended recipient, but with vastly reduced risk. For attachments which are visual in nature, such as images, PDFs and Microsoft Office formats, the attachments will be processed into an image format and subsequently rendered into a PDF (in the case of Microsoft Office formats and PDFs) or into an image of the original file format (if an image). In some email systems, the email attachment may be initially removed and replaced with a notification informing the user that the attachment is undergoing processing. When processing is complete the converted attachment will be inserted back into the email.

Double Lock Links 1465: The autonomous response module 140 replaces the URL with a redirected Email link. If the link is clicked, the user will be presented with a notification to that user that they are not permitted to access the original destination of the link. The user will be unable to follow the link to the original source, but their intent to follow the link will be recorded by the data store via the autonomous response module 140.

Strip Attachments 1470: The autonomous response module 140 strips one or more attachments of this email. Most file formats are delivered as converted attachments; file formats which do not convert to visible documents (e.g., executables, compressed types) are stripped to reduce risk. The ‘Strip attachment’ action will cause the system to remove the attachment from the email and replace it with a file informing the user that the original attachment was removed.

Junk action 1475: The autonomous response module 140 will ensure the email classified as junk or other malicious email is diverted to the recipient's junk folder, or other nominated destination such as ‘quarantine’.

The types of actions and specific actions conducted by the autonomous response module 140 may be customizable for different users and parts of the system; and thus, configurable for the domain administrator to approve/set for the autonomous response module 140 to automatically take those actions and when to automatically take those actions.

For instance, the autonomous response module 140 may have access to a library of response action types of actions and specific actions the autonomous response module 140 is capable of, including focused response actions selectable through the user interface that are contextualized to autonomously act on specific email elements of a malicious email, rather than a blanket quarantine or block approach on that email, to avoid business disruption to a particular user of the email system. The autonomous response module 140 is able to take measured, varied actions towards those email communications to minimize business disruption in a reactive, contextualized manner.

As described above, a user may customize the actions (including approving, preventing, or modifying) taken by the autonomous response module 140 via the interactive user interface of the appliance extension 210 from a mobile device.

The autonomous response module 140 may work hand-in-hand with the AI models to neutralize malicious emails, and deliver preemptive protection against targeted, email-borne attack campaigns in real time.

The cyber threat analyst module 125 or email module 145 cooperating with the autonomous response module 140 can detect and contain, for example, an infection in the network, recognize that the infection had an email as its source, and identify and neutralize that malicious email by either removing that from the corporate email account inboxes, or simply stripping the malicious portion of that before the email reaches its intended user. The autonomous actions range from flattening attachments or stripping suspect links, through to holding emails back entirely if they pose a sufficient risk.

The cyber threat analyst module 125 can identify the source of the compromise and then invoke an autonomous response action by sending a request to the autonomous response model. This autonomous response action will rapidly stop the spread of an emerging attack campaign and give human responders the crucial time needed to catch up.

In an embodiment, initially, the autonomous response module 140 can be run in human confirmation mode—all autonomous, intelligent interventions must be confirmed initially by a human operator. As the autonomous response module 140 refines and nuances its understanding of an organization's email behavior, the level of autonomous action can be increased until no human supervision is required for each autonomous response action. Most security teams will spend little time in the user interface once this level is reached. At this time, the autonomous response module 140 response action neutralizes malicious emails without the need for any active management. The autonomous response module 140 may take one or more proactive or reactive action against emails, which are observed as potentially malicious. Actions are triggered by threat alerts or by a level of anomalous behavior as defined and detected by the cyber-security system and offer highly customizable, targeted response actions to email threats that allows the end user to remain safe without interruption. Suspect email content can be held in full, autonomously with selected users exempted from this policy, for further inspection or authorization for release. User behavior and notable incidents can be mapped, and detailed, comprehensive email logs can be filtered by a vast range of metrics compared to the model of normal behavior to release or strip potentially malicious content from the email.

In relation to the detection of email campaigns on the email system, the cloud platform can aggregate those targeted campaigns of malicious emails centrally with a centralized fleet aggregator 305 (see FIG. 18). The centralized fleet aggregator 305 looks for these trends, anomalies, and then from that the centralized mechanism can drive detected trends like autonomous action responses by transmitting that information back out to local cyber security appliances deployed throughout the fleet. The aggregation of that data which is fed to an AI classifier to ascertain whether this email campaign is occurring in certain region(s), across certain industries, sent from a same entity, sent from a same geographic location, etc. The centralized fleet aggregator 305 puts this information into a format which is usable for the fleet of deployed cyber security appliances in general, as well as notices sent to marketing and customer support.

An email similarity classifier logic and targeted campaign classifier logic cooperate in the email threat detector logic to provide an early warning system to predict a sustained and malicious email campaign by analyzing, for example, a type of action taken by the autonomous response on a set of emails with similar overlapping features. The early warning system in the email threat detector logic is configured to predict a sustained, email campaign of actually malicious emails by analyzing the type of action taken by the autonomous response on a set of emails with many overlapping features and factoring in a pattern of email analysis occurring across a fleet of two or more cyber security appliances deployed and protecting email systems to detect trends. The “early warning” system can be a fleetwide approach that tries to detect trends across all of our deployed cyber security appliances, with the individual email threat detector logic in the local cyber security appliance trying to do so on a per cyber security appliance basis. The email threat detector logic can detect campaigns early, before they are written about; and thus, generate reports to the end user about a new email campaign.

One or more of the AI models 160 communicatively couple to the email threat detector logic. The one or more AI models 160 are configured to analyze the emails under analysis and then output results to detect malicious emails. The email threat detector logic is configured to cooperate with the one or more AI models 160 to identify emails that are deemed malicious. The existing framework of cyber threat detection via the modules and models and autonomous response via the autonomous response module 140 to mitigate the detected threat in the email domain is capable of successfully identifying and reacting to malicious emails. Autonomous action responses are decided on an email-by-email basis and include, for example, holding a message for further investigation, sending it to the junk folder, disabling hyperlinks, etc. before delivery to the destination inbox.

The email threat detector logic and autonomous response module 140 can cooperate to analyze what level of autonomous action is initiated by the autonomous response module 140 to mitigate emails in the cluster of emails with similar characteristics compared to a historical norm of autonomous actions to past groups of clusters of emails with similar characteristics. The comparison is made and when different and more severe than the historical norm, then the email threat detector logic 180 can consider the different and more severe autonomous action taken on the cluster of emails as a factor indicating that the targeted campaign of malicious emails is underway. The email threat detector logic uses both statistical approaches and machine learning. The email threat detector logic also tracks and compares the historical data. The email threat detector logic has the machine learning aspect to fit and create sensible bounds of what we would expect to see within each of these periods. The email threat detector logic can look at the mean and medium as well as machine learning modeled normal pattern of behavior as bound indicators of whether there is a campaign and how serious the campaign is.

The email threat detector logic can look at time periods within a given time frame to detect pretty quickly whether this email network being protected is getting a campaign of emails building up and occurring, by looking at and comparing to the machine learning averages as well as the mathematical means and median values, etc. to the current numbers. The email threat detector logic can detect, for example, an uptick in more severe autonomous responses and that is indicative of building up to an ongoing email attack campaign. The uptick in severity of the autonomous responses that the autonomous response module 140 takes is more severe than what the system normally and/or historically sees in this organization's email domain. The malicious actor conducting the ongoing email attack campaign generally sends test bad emails to figure out what defenses and vulnerabilities the organization's email domain has before the full en-masse sending of emails occurs. Also, an email report analysis logic can look at elapsed time periods to quickly determine whether a query is needed to DNS and/or one or more ISPs to obtain email authentication reports to ensure that the domain interaction is policed over during a prescribed time frame.

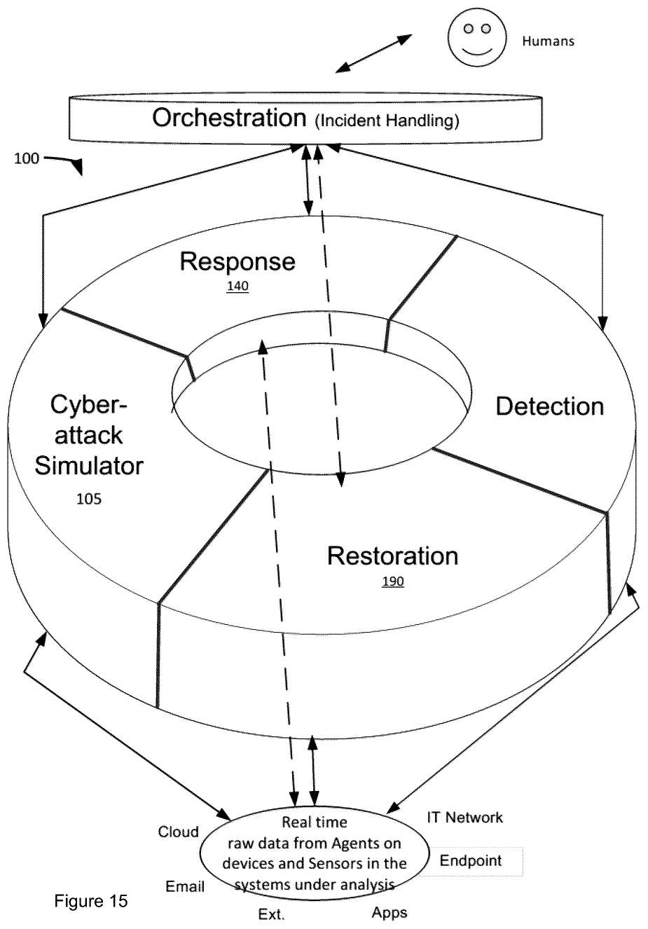

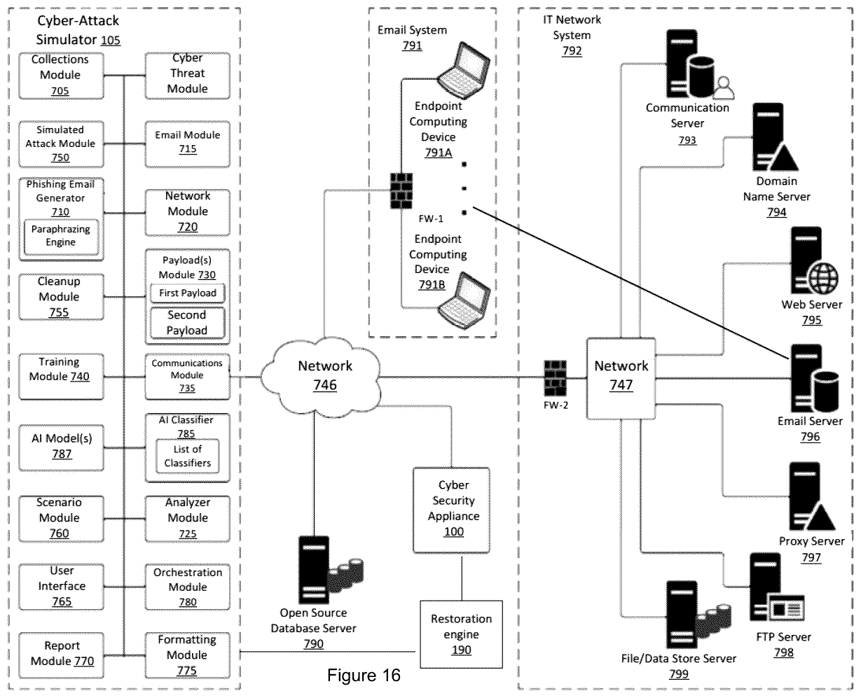

Referring to FIG. 15, an example of multiple Artificial Intelligence-based engines cooperating with each other can include i) the cyber threat detection engine, ii) an autonomous response engine 140, iii) a cyber-security restoration engine 190, and iv) a cyber-attack simulator. i) The cyber threat detection engine (consisting of the modules making up the cyber security appliance 100) can be configured to use Artificial Intelligence algorithms trained to perform a machine-learned task of detecting the cyber threat. (See for example FIG. 13) ii) The autonomous response engine 140 can be configured to use Artificial Intelligence algorithms trained to perform a machine-learned task of taking one or more mitigation actions to mitigate the cyber threat. iii) The cyber-security restoration engine 190 can be configured to use Artificial Intelligence algorithms trained to perform a machine-learned task of remediating the system being protected back to a trusted operational state. iv) The cyber-attack simulator can be configured to use Artificial Intelligence algorithms trained to perform a machine-learned task of Artificial Intelligence-based simulations of cyberattacks to assist in determining 1) how a simulated cyberattack might occur in the system being protected, and 2) how to use the simulated cyberattack information to preempt possible escalations of an ongoing actual cyberattack (see, for example, FIG. 16).

The appliance extension may be configured to perform functions with one or more of the Artificial-Intelligence based engines described in relation to FIG. 15. In particular, as described, the appliance extension is configured to provide the user, via the interactive user interface, control over the information displayed based on information from one or more of the Artificial-Intelligence based engines and control over the actions taken by one or more of the Artificial-intelligence based engines.

The cyber security restoration engine or restoration module 190 is configured to take one or more remediation actions based on configured and/or Artificial Intelligence assistance to remediate the one or more nodes in the graph of the system being protected back to a trusted operational state in a recovery from the cyber threat. These actions might be fully automatic or require a specific human confirmation decision before they begin. The cyber security restoration module 190 is configured to cooperate with the other AI-based engines of the cyber security system, via the interfaces and/or direct integrations, to track and understand the cyber threat identified by the other components as well as track the one or more mitigation actions taken to mitigate the cyber threat during the cyberattack by the other components in order to assist in intelligently restoring the protected system while still mitigating the cyber threat attack back to a trusted operational state; and thus, as a situation develops with an ongoing cyberattack, the cyber security restoration engine 190 is configured to take one or more remediation actions to remediate (e.g. restore) at least one of the nodes in the graph of the protected system back to a trusted operational state while the cyberattack is still ongoing.

The cyber-security restoration engine 190 receives and sends inputs through communication hooks (e.g.) interfaces to all of these Artificial Intelligence-based engines each configured with self-learning AI machine learning algorithms to, respectively, i) to detect the cyber threat, ii) to respond to mitigate that cyber threat, and iii) to predict how that cyber threat might occur and likely progress through simulations. Each of these Artificial Intelligence-based engines has bi-directional communications, including the exchange of raw data, with each other as well as with software agents resident in physical and/or virtual devices making up the system being protected as well as bi-directional communications with sensors within the system being protected. Note, the system under protection can be, for example, an email network, an IT network, an OT network, a Cloud network, a source code database, an endpoint device, etc.

The appliance extension may be further configured to interact with a restoration module described in relation to FIG. 15. In particular, the appliance extension is further configured to perform functions with a restoration module configured to perform a machine-learned task of remediating the system back to a trusted operational state after a cyber threat is countered. The appliance extension is also configured to receive one or more recommended restoration actions from the restoration module and display the restoration actions on the interactive user interface. The interactive user interface is configured to receive one or more inputs to approve, prevent, or modify the recommended restoration actions. The appliance extension is further configured to send one or more control signals to control the restoration module to perform the one or more recommended restoration actions, perform the modified recommended restoration actions, or prevent performance of the recommended restoration actions.

The appliance extension therefore enables a user to control or modify the actions taken by the restoration engine via the interactive user interface.

The multiple Artificial Intelligence-based engines have communication hooks in between them to exchange a significant amount of behavioral metrics including data between the multiple Artificial Intelligence-based engines to work in together to provide an overall cyber threat response.

An intelligent orchestration component can be configured as a discreet intelligent orchestration component that exists on top of the multiple Artificial Intelligence-based engines to orchestrate the overall cyber threat response and an interaction between the multiple Artificial Intelligence-based engines, each configured to perform its own machine-learned task. Alternatively, the intelligent orchestration component can be configured as a distributed collaboration with a portion of the intelligent orchestration component implemented in each of the multiple Artificial Intelligence-based engines to orchestrate the overall cyber threat response and an interaction between the multiple Artificial Intelligence-based engines. In an embodiment, whether implemented as a distributed portion on each AI engine or a discrete AI engine itself, the intelligent orchestration component can use self-learning algorithms to learn how to best assist the orchestration of the interaction between itself and the other AI engines, which also implement self-learning algorithms themselves to perform their individual machine-learned tasks better.

The multiple Artificial Intelligence-based engines can be configured to cooperate to combine an understanding of normal operations of the nodes, an understanding emerging cyber threats, an ability to contain those emerging cyber threats, and a restoration of the nodes of the system to heal the system with an adaptive feedback between the multiple Artificial Intelligence-based engines in light of simulations of the cyberattack to predict what might occur in the nodes in the system based on the progression of the attack so far, mitigation actions taken to contain those emerging cyber threats and remediation actions taken to heal the nodes using the simulated cyberattack information.

One or more Artificial Intelligence models in the detection engine can be configured to maintain what is considered to be normal behavior for that node, which is constructed on a per node basis, on the system being protected from historical data of that specific node over an operation of the system being protected.

The multiple Artificial Intelligence-based engines each have an interface to communicate with the other separate Artificial Intelligence-based engines configured to understand a type of information and communication that the other separate Artificial Intelligence-based engine needs to make determinations on an ongoing cyberattack from that other Artificial Intelligence-based engine's perspective. Each Artificial Intelligence-based engine has an instant messaging system to communicate with a human cyber-security team to keep the human cyber-security team informed on actions autonomously taken and actions needing human approval as well as generate reports for the human cyber-security team.

In addition, the intelligent orchestration component can use Artificial Intelligence algorithms trained to perform a fifth machine-learned task of adaptive interactive response between the multiple Artificial Intelligence-based engines to provide information each Artificial Intelligence engine needs to work cohesively to provide an overall incidence response that mitigates different types of cyber threats while still minimizing an impact tailored to this particular system being protected. For example, when a conversation occurs between the AI-based engines such as a system that can be positively affected by both proposed mitigation actions and proposed restoration actions, any of which might be attempted but fail or only partially succeed, then the intelligent orchestration component can arbitrate and evolve the best result for this particular system being protected. The intelligent orchestration component can help anticipate i) the needs of and ii) cohesive response of each Artificial Intelligence-based engine based on a current detected cyber threat.

In an example, the autonomous response engine 140 uses its intelligence to cooperate with a cyber-attack simulator and its Artificial Intelligence-based simulations to choose and initiate an initial set of one or more mitigation actions indicated as a preferred targeted initial response to the detected cyber threat by autonomously initiating those mitigation actions to defend against the detected cyber threat, rather than a human taking an action. The autonomous response engine 140, rather than the human taking the action, is configured to autonomously cause the one or more mitigation actions to be taken to contain the cyber threat when a threat risk parameter from an assessment module in the detection engine is equal to or above an actionable threshold. Example mitigation actions can include 1) the autonomous response engine 140 monitoring and sending signals to a potentially compromised node to restrict communications of the potentially compromised node to merely normal recipients and types of communications according to the Artificial Intelligence model trained to model the normal pattern of life for each node in the protected system, 2) the autonomous response engine 140 trained on how to isolate a compromised node as well as to take mitigation acts with other nodes that have a direct nexus to the compromised node.

In another example, the cyber-attack simulator and its Artificial Intelligence-based simulations use intelligence to cooperate with the cyber-security restoration engine 190 to assist in choosing one or more remediation actions to perform on nodes affected by the cyberattack back to a trusted operational state while still mitigating the cyber threat during an ongoing cyberattack based on effects determined through the simulation of possible remediation actions to perform and their effects on the nodes making up the system being protected and preempt possible escalations of the cyberattack while restoring one or more nodes back to a trusted operational state.

In another example, the cyber security restoration engine 190 restores the one or more nodes in the protected system by cooperating with at least two or more of 1) an Artificial Intelligence model trained to model a normal pattern of life for each node in the protected system, 2) an Artificial Intelligence model trained on what are a possible set of cyber threats and their characteristics and symptoms to identify the cyber threat (e.g. malicious actor/device/file) that is causing a particular node to behave abnormally (e.g. malicious behavior) and fall outside of that node's normal pattern of life, and 3) the autonomous response engine 140.

FIG. 16 illustrates a block diagram of an embodiment of the cyber-attack simulator with Artificial Intelligence-based simulations conducted in the cyber-attack simulator by constructing a graph of nodes of the system being protected (e.g. a network including i) the physical devices connecting to the network, any virtualized instances of the network, user accounts in the network, email accounts in the network, etc. as well as ii) connections and pathways through the network) to create a virtualized instance of the network to be tested. As shown in FIG. 16, the various cooperating modules residing in the cyber-attack simulator 105 may include, but are not limited to, a collections module 705, a cyberattack generator (e.g. phishing email generator with a paraphrasing engine) 702, an email module 715, a network module 720, an analyzer module 725, a payloads module 730 with first and second payloads, a communication module 735, a training module 740, a simulated attack module 750, a cleanup module 755, a scenario module 760, a user interface 765, a reporting module, a formatting module, an orchestration module, an AI classifier with a list of specified classifiers.

The cyber-attack simulator 105 may be implemented via i) a simulator to model the system being protected and/or ii) a clone creator to spin up a virtual network and create a virtual clone of the system being protected configured to pentest one or more defenses provided by scores based on both the level of confidence that the cyber threat is a viable threat and the severity of the cyber threat (e.g., attack type where ransomware attacks has greater severity than phishing attack; degree of infection; computing devices likely to be targeted, etc.). The threat risk scores be used to rank alerts that may be directed to enterprise or computing device administrators. This risk assessment and ranking is conducted to avoid frequent “false positive” alerts that diminish the degree of reliance/confidence on the cyber security appliance 100. The cyber-attack simulator 105 may include and cooperate with one or more AI models trained with machine learning on the contextual knowledge of the organization. These trained AI models may be configured to identify data points from the contextual knowledge of the organization and its entities, which may include, but is not limited to, language-based data, email/network connectivity and behavior pattern data, and/or historic knowledgebase data. The cyber-attack simulator 105 may use the trained AI models to cooperate with one or more AI classifier(s) by producing a list of specific organization-based classifiers for the AI classifier. The cyber-attack simulator 105 is further configured to calculate, based at least in part on the results of the one or more hypothetical simulations of a possible cyberattack and/or of an actual ongoing cyberattack from a cyber threat determine a risk score for each node (e.g. each device, user account, etc.), the threat risk score being indicative of a possible severity of the compromise prior to an autonomous response action is taken in response to the actual cyberattack of the cyber incident.

The appliance extension may be configured to perform functions with the cyberattack simulation module configured to perform a machine-learned task of initiating and monitoring a cyberattack simulation on the system. The appliance extension may be configured to display, on the interactive user interface, metrics related to the progression of the simulated cyberattack, and receive one or more user inputs via the interactive user interface to modify the simulated cyberattack. The appliance extension may then be configured to send one or more control signals to the cyberattack simulation module to modify the simulated cyberattack. Thus, the user may be enabled to view and control the functioning of the cyberattack simulator from the appliance extension on the user's mobile device.

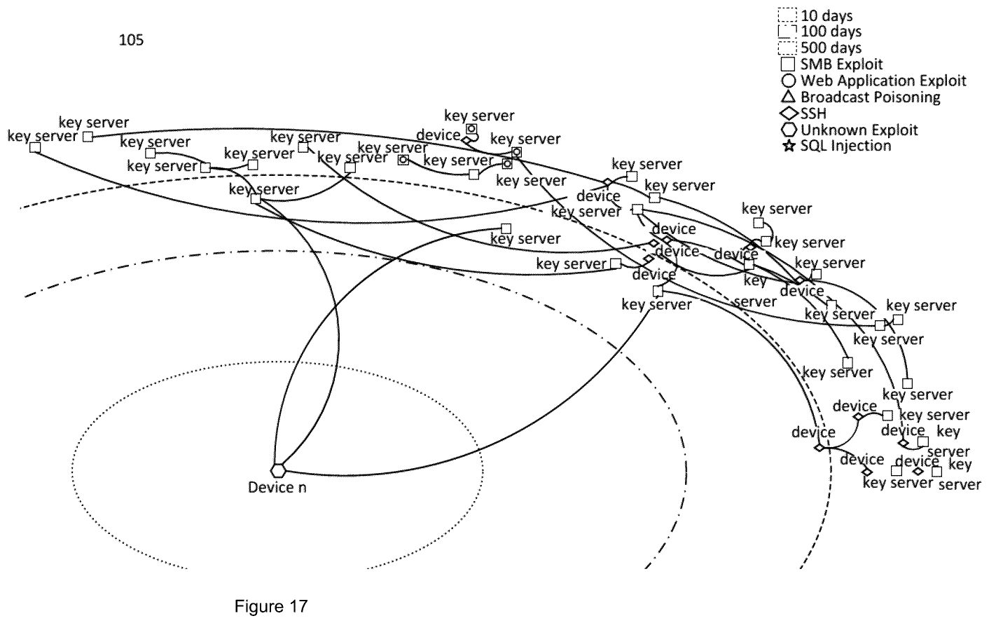

FIG. 17 illustrates a diagram of an embodiment of the cyber-attack simulator and its Artificial Intelligence-based simulations constructing an example graph of nodes in an example network and simulating how the cyberattack might likely progress in the future tailored with an innate understanding of a normal behavior of the nodes in the system being protected and a current operational state of each node in the graph of the protected system during simulations of cyberattacks. The cyber-attack simulator 105 plots the attack path through the nodes and estimated times to reach critical nodes in the network. The cyberattack simulation modeling is run to identify the routes, difficulty, and time periods from certain entry notes to certain key servers.

Again, similarly named components in each Artificial Intelligence-based engine can 1) perform similar functions and/or 2) have a communication link from that component located in one of the Artificial Intelligence-based engines and then information is needed from that component is communicated to another Artificial Intelligence-based engine that through the interface to that Artificial Intelligence-based engine.

Training of AI Pre-Deployment and then During Deployment

In step 1, an initial training of the Artificial Intelligence model trained on cyber threats can occur using unsupervised learning and/or supervised learning on characteristics and attributes of known potential cyber threats including malware, insider threats, and other kinds of cyber threats that can occur within that domain. Each Artificial Intelligence can be programmed and configured with the background information to understand and handle particulars, including different types of data, protocols used, types of devices, user accounts, etc. of the system being protected. The Artificial Intelligence pre-deployment can all be trained on the specific machine learning task that they will perform when put into deployment. For example, the AI model, such as AI model(s) 160 or example (hereinafter “AI model(s) 160”), trained on identifying a specific cyber threat learns at least both in the pre-deployment training i) the characteristics and attributes of known potential cyber threats as well as ii) a set of characteristics and attributes of each category of potential cyber threats and their weights assigned on how indicative certain characteristics and attributes correlate to potential cyber threats of that category of threats. In this example, one of the AI model(s) 160 trained on identifying a specific cyber threat can be trained with machine learning such as Linear Regression, Regression Trees, Non-Linear Regression, Bayesian Linear Regression, Deep learning, etc. to learn and understand the characteristics and attributes in that category of cyber threats. Later, when in deployment in a domain/network being protected by the cyber security appliance 100, the AI model trained on cyber threats can determine whether a potentially unknown threat has been detected via a number of techniques including an overlap of some of the same characteristics and attributes in that category of cyber threats. The AI model may use unsupervised learning when deployed to better learn newer and updated characteristics of cyberattacks.

In an embodiment, one or more of the AI models 160 may be trained on a normal pattern of life of entities in the system are self-learning AI model using unsupervised machine learning and machine learning algorithms to analyze patterns and ‘learn’ what is the ‘normal behavior’ of the network by analyzing data on the activity on, for example, the network level, at the device level, and at the employee level. The self-learning AI model using unsupervised machine learning understands the system under analysis' normal patterns of life in, for example, a week of being deployed on that system, and grows more bespoke with every passing minute. The AI unsupervised learning model learns patterns from the features in the day-to-day dataset and detecting abnormal data which would not have fallen into the category (cluster) of normal behavior. The self-learning AI model using unsupervised machine learning can simply be placed into an observation mode for an initial week or two when first deployed on a network/domain in order to establish an initial normal behavior for entities in the network/domain under analysis.

Thus, a deployed Artificial Intelligence model 160 trained on a normal behavior of entities in the system can be configured to observe the nodes in the system being protected. Training on a normal behavior of entities in the system can occur while monitoring for the first week or two until enough data has been observed to establish a statistically reliable set of normal operations for each node (e.g., user account, device, etc.). Initial training of one or more Artificial Intelligence models 160 trained with machine learning on a normal behavior of the pattern of life of the entities in the network/domain can occur where each type of network and/or domain will generally have some common typical behavior with each model trained specifically to understand components/devices, protocols, activity level, etc. to that type of network/system/domain. Alternatively, pre-deployment machine learning training of one or more Artificial Intelligence models trained on a normal pattern of life of entities in the system can occur. Initial training of one or more Artificial Intelligence models trained with machine learning on a behavior of the pattern of life of the entities in the network/domain can occur where each type of network and/or domain will generally have some common typical behavior with each model trained specifically to understand components/devices, protocols, activity level, etc. to that type of network/system/domain. What is normal behavior of each entity within that system can be established either prior to deployment and then adjusted during deployment or alternatively the model can simply be placed into an observation mode for an initial week or two when first deployed on a network/domain in order to establish an initial normal behavior for entities in the network/domain under analysis. During deployment, what is considered normal behavior will change as each different entity's behavior changes and will be reflected through the use of unsupervised learning in the model such as various Bayesian techniques, clustering, etc. The AI models 160 can be implemented with various mechanisms such neural networks, decision trees, etc. and combinations of these. Likewise, one or more supervised machine learning AI models 160 may be trained to create possible hypotheses and perform cyber threat investigations on agnostic examples of past historical incidents of detecting a multitude of possible types of cyber threat hypotheses previously analyzed by human cyber security analyst. More on the training of AI models 160 are trained to create one or more possible hypotheses and perform cyber threat investigations will be discussed later.

At its core, the self-learning AI models 160 that model the normal behavior (e.g. a normal pattern of life) of entities in the network mathematically characterizes what constitutes ‘normal’ behavior, based on the analysis of a large number of different measures of a device's network behavior—packet traffic and network activity/processes including server access, data volumes, timings of events, credential use, connection type, volume, and directionality of, for example, uploads/downloads into the network, file type, packet intention, admin activity, resource and information requests, command sent, etc.

### Clustering Methods

In order to model what should be considered as normal for a device or cloud container, its behavior can be analyzed in the context of other similar entities on the network. The AI models (e.g., AI model(s) 160) can use unsupervised machine learning to algorithmically identify significant groupings, a task which is virtually impossible to do manually. To create a holistic image of the relationships within the network, the AI models and AI classifiers employ a number of different clustering methods, including matrix-based clustering, density-based clustering, and hierarchical clustering techniques. The resulting clusters can then be used, for example, to inform the modeling of the normative behaviors and/or similar groupings.

The AI models and AI classifiers can employ a large-scale computational approach to understand sparse structure in models of network connectivity based on applying L1-regularization techniques (the lasso method). This allows the artificial intelligence to discover true associations between different elements of a network which can be cast as efficiently solvable convex optimization problems and yield parsimonious models. Various mathematical approaches assist.

Next, one or more supervised machine learning AI models are trained to create possible hypotheses and how to perform cyber threat investigations on agnostic examples of past historical incidents of detecting a multitude of possible types of cyber threat hypotheses previously analyzed by human cyber threat analysis. AI models trained on forming and investigating hypotheses on what are a possible set of cyber threats can be trained initially with supervised learning. Thus, these AI models can be trained on how to form and investigate hypotheses on what are a possible set of cyber threats and steps to take in supporting or refuting hypotheses. The AI models trained on forming and investigating hypotheses are updated with unsupervised machine learning algorithms when correctly supporting or refuting the hypotheses including what additional collected data proved to be the most useful. More on the training of the AI models that are trained to create one or more possible hypotheses and perform cyber threat investigations will be discussed later.

Next, the various Artificial Intelligence models and AI classifiers combine use of unsupervised and supervised machine learning to learn ‘on the job’—it does not depend upon solely knowledge of previous cyber threat attacks. The Artificial Intelligence models and classifiers combine use of unsupervised and supervised machine learning constantly revises assumptions about behavior, using probabilistic mathematics, that is always up to date on what a current normal behavior is, and not solely reliant on human input. The Artificial Intelligence models and classifiers combine use of unsupervised and supervised machine learning on cyber security is capable of seeing hitherto undiscovered cyber events, from a variety of threat sources, which would otherwise have gone unnoticed.

Next, these cyber threats can include, for example: Insider threat—malicious or accidental, Zero-day attacks—previously unseen, novel exploits, latent vulnerabilities, machine-speed attacks—ransomware and other automated attacks that propagate and/or mutate very quickly, Cloud and SaaS-based attacks, other silent and stealthy attacks advance persistent threats, advanced spear-phishing, etc.

### Ranking the Cyber Threat

The assessment module 125 and/or cyber threat analyst module 120 of FIG. 4 can cooperate with the AI model(s) 160 trained on possible cyber threats to use AI algorithms to account for ambiguities by distinguishing between the subtly differing levels of evidence that characterize network data. Instead of generating the simple binary outputs ‘malicious’ or ‘benign’, the AI's mathematical algorithms produce outputs marked with differing degrees of potential threat. This enables users of the system to rank alerts and notifications to the enterprise security administrator in a rigorous manner and prioritize those which most urgently require action. Meanwhile, it also assists to avoid the problem of numerous false positives associated with simply a rule-based approach.

### More on the Operation of the Cyber Security Appliance 100

As discussed in more detail below, the analyzer module 115 and/or cyber threat analyst module 120 can cooperate with the one or more unsupervised AI (machine learning) model 160 trained on the normal pattern of life/normal behavior in order to perform anomaly detection against the actual normal pattern of life for that system to determine whether an anomaly (e.g., the identified abnormal behavior and/or suspicious activity) is malicious or benign. In the operation of the cyber security appliance 100, the emerging cyber threat can be previously unknown, but the emerging threat landscape data 170 representative of the emerging cyber threat shares enough (or does not share enough) in common with the traits from the AI models 160 trained on cyber threats to now be identified as malicious or benign. Note, if later confirmed as malicious, then the AI models 160 trained with machine learning on possible cyber threats can update their training. Likewise, as the cyber security appliance 100 continues to operate, then the one or more AI models trained on a normal pattern of life for each of the entities in the system can be updated and trained with unsupervised machine learning algorithms. The analyzer module 115 can use any number of data analysis processes (discussed more in detail below and including the agent analyzer data analysis process here) to help obtain system data points so that this data can be fed and compared to the one or more AI models trained on a normal pattern of life, as well as the one or more machine learning models trained on potential cyber threats, as well as create and store data points with the connection finger prints.

All of the above AI models 160 can continually learn and train with unsupervised machine learning algorithms on an ongoing basis when deployed in their system that the cyber security appliance 100 is protecting. Thus, learning and training on what is normal behavior for each user, each device, and the system overall and lowering a threshold of what is an anomaly.

### Anomaly Detection/Deviations

Anomaly detection can discover unusual data points in your dataset. Anomaly can be a synonym for the word ‘outlier’. Anomaly detection (or outlier detection) is the identification of rare items, events or observations which raise suspicions by differing significantly from the majority of the data. Anomalous activities can be linked to some kind of problems or rare events. Since there are tons of ways to induce a particular cyber-attack, it is very difficult to have information about all these attacks beforehand in a dataset. But, since the majority of the user activity and device activity in the system under analysis is normal, the system overtime captures almost all of the ways which indicate normal behavior. And from the inclusion-exclusion principle, if an activity under scrutiny does not give indications of normal activity, the self-learning AI model using unsupervised machine learning can predict with high confidence that the given activity is anomalous. The AI unsupervised learning model learns patterns from the features in the day to day dataset and detecting abnormal data which would not have fallen into the category (cluster) of normal behavior. The goal of the anomaly detection algorithm through the data fed to it is to learn the patterns of a normal activity so that when an anomalous activity occurs, the modules can flag the anomalies through the inclusion-exclusion principle. The goal of the anomaly detection algorithm through the data fed to it is to learn the patterns of a normal activity so that when an anomalous activity occurs, the modules can flag the anomalies through the inclusion-exclusion principle. The cyber threat module can perform its two level analysis on anomalous behavior and determine correlations.

In an example, 95% of data in a normal distribution lies within two standard-deviations from the mean. Since the likelihood of anomalies in general is very low, the modules cooperating with the AI model of normal behavior can say with high confidence that data points spread near the mean value are non-anomalous. And since the probability distribution values between mean and two standard-deviations are large enough, the modules cooperating with the AI model of normal behavior can set a value in this example range as a threshold (a parameter that can be tuned over time through the self-learning), where feature values with probability larger than this threshold indicate that the given feature's values are non-anomalous, otherwise it's anomalous. Note, this anomaly detection can determine that a data point is anomalous/non-anomalous on the basis of a particular feature. In reality, the cyber security appliance 100 should not flag a data point as an anomaly based on a single feature. Merely, when a combination of all the probability values for all features for a given data point is calculated can the modules cooperating with the AI model of normal behavior can say with high confidence whether a data point is an anomaly or not. Anomaly detection can discover unusual data points in your dataset. Anomaly can be sometimes a synonym for the word ‘outlier’.

Again, the AI models trained on a normal pattern of life of entities in a network (e.g., domain) under analysis may perform the cyber threat detection through a probabilistic change in a normal behavior through the application of, for example, an unsupervised Bayesian mathematical model to detect the behavioral change in computers and computer networks. The Bayesian probabilistic approach can determine periodicity in multiple time series data and identify changes across single and multiple time series data for the purpose of anomalous behavior detection. Please reference U.S. Pat. No. 10,701,093 granted Jun. 30, 2020, titled “Anomaly alert system for cyber threat detection” for an example Bayesian probabilistic approach, which is incorporated by reference in its entirety. In addition, please reference US patent publication number “US2021273958A1 filed Feb. 26, 2021, titled “Multi-stage anomaly detection for process chains in multi-host environments” for another example anomalous behavior detector using a recurrent neural network and a bidirectional long short-term memory (LSTM), which is incorporated by reference in its entirety. In addition, please reference US patent publication number “US2020244673A1, filed Apr. 23, 2019, titled “Multivariate network structure anomaly detector,” which is incorporated by reference in its entirety, for another example anomalous behavior detector with a Multivariate Network and Artificial Intelligence classifiers.

Next, as discussed further below, as discussed further below, during pre-deployment the cyber threat analyst module 120 and the analyzer module 115 can use data analysis processes and cooperate with AI model(s) 160 trained on forming and investigating hypotheses on what are a possible set of cyber threats. In addition, another set of AI models can be trained on how to form and investigate hypotheses on what are a possible set of cyber threats and steps to take in supporting or refuting hypotheses. The AI models trained on forming and investigating hypotheses are updated with unsupervised machine learning algorithms when correctly supporting or refuting the hypotheses including what additional collected data proved to be the most useful.

Similarly, during deployment, the data analysis processes (discussed herein) used by the analyzer module 115 can use unsupervised machine learning to update the initial training learned during pre-deployment, and then update the training with unsupervised learning algorithms during the cyber security appliance's 100 deployment in the system being protected when various different steps to either i) support or ii) refute the possible set of cyber threats hypotheses worked better or worked worse.

The AI model(s) 160 trained on a normal pattern of life of entities in a domain under analysis may perform the threat detection through a probabilistic change in a normal behavior through the application of, for example, an unsupervised Bayesian mathematical model to detect a behavioral change in computers and computer networks. The Bayesian probabilistic approach can determine periodicity in multiple time series data and identify changes across single and multiple time series data for the purpose of anomalous behavior detection. In an example, a system being protected can include both email and IT network domains under analysis. Thus, email and IT network raw sources of data can be examined along with a large number of derived metrics that each produce time series data for the given metric.

### Additional Module Interactions

Referring back to FIG. 13, the gather module 110 cooperates with the data store 135. The data store 135 stores comprehensive logs for network traffic observed. These logs can be filtered with complex logical queries and each IP packet can be interrogated on a vast number of metrics in the network information stored in the data store. Similarly, other domain's communications and data, such as emails, logs, etc. may be collected and stored in the data store 135. The gather module 110 may consist of multiple automatic data gatherers that each look at different aspects of the data depending on the particular hypothesis formed for the analysed event. The data relevant to each type of possible hypothesis can be automatically pulled from additional external and internal sources. Some data is pulled or retrieved by the gather module 110 for each possible hypothesis.

The data store 135 can store the metrics and previous threat alerts associated with network traffic for a period of time, which is, by default, at least 27 days. This corpus of data is fully searchable. The cyber security appliance 100 works with network probes to monitor network traffic and store and record the data and metadata associated with the network traffic in the data store.

The gather module 110 may have a process identifier classifier. The process identifier classifier can identify and track each process and device in the network, under analysis, making communication connections. The data store 135 cooperates with the process identifier classifier to collect and maintain historical data of processes and their connections, which is updated over time as the network is in operation. In an example, the process identifier classifier can identify each process running on a given device along with its endpoint connections, which are stored in the data store. Similarly, data from any of the domains under analysis may be collected and compared.

Examples of domains/networks under analysis being protected can include any of i) an Informational Technology network, ii) an Operational Technology network, iii) a Cloud service, iv) a SaaS service, v) an endpoint device, vi) an email domain, and vii) any combinations of these. A domain module is constructed and coded to interact with and understand a specific domain.

For instance, the first domain module 145 is, in this example, an email module configured to receive information from and send information to, in this example, email-based sensors (i.e., probes, taps, etc.). The email module 145 also has algorithms and components configured to understand, in this example, email parameters, email protocols and formats, email activity, and other email characteristics of the network under analysis. The second domain module 150 may operate as an IT network module configured to receive information from and send information to, in this example, IT network-based sensors (i.e., probes, taps, etc.). The second domain module 150 also has algorithms and components configured to understand, in this example, IT network parameters, IT network protocols, IT network activity, and other IT network characteristics of the network under analysis. Additional domain modules can also collect domain data from another respective domain.

The coordinator module 155 is configured to work with various machine learning algorithms and relational mechanisms to i) assess, ii) annotate, and/or iii) position in a vector diagram, a directed graph, a relational database, etc., activity including events occurring, for example, in the first domain compared to activity including events occurring in the second domain. The domain modules can cooperate to exchange and store their information with the data store.

The process identifier classifier (not shown) in the gather module 110 can cooperate with additional classifiers in each of the domain modules 145/150 to assist in tracking individual processes and associating them with entities in a domain under analysis as well as individual processes and how they relate to each other. The process identifier classifier can cooperate with other trained AI classifiers in the modules to supply useful metadata along with helping to make logical nexuses.

A feedback loop of cooperation exists between the gather module 110, the analyzer module 115, AI model(s) 160 trained on different aspects of this process, and the cyber threat analyst module 120 to gather information to determine whether a cyber threat is potentially attacking the networks/domains under analysis.

### Determination of Whether Something is Likely Malicious.

In the following examples the analyzer module 115 and/or cyber threat analyst module 120 can use multiple factors to the determination of whether a process, event, object, entity, etc. is likely malicious.

In an example, the analyzer module 115 and/or cyber threat analyst module 120 can cooperate with one or more of the AI model(s) 160 trained on certain cyber threats to detect whether the anomalous activity detected, such as suspicious email messages, exhibit traits that may suggest a malicious intent, such as phishing links, scam language, sent from suspicious domains, etc. The analyzer module 115 and/or cyber threat analyst module 120 can also cooperate with one of more of the AI model(s) 160 trained on potential IT based cyber threats to detect whether the anomalous activity detected, such as suspicious IT links, URLs, domains, user activity, etc., may suggest a malicious intent as indicated by the AI models trained on potential IT based cyber threats.

In the above example, the analyzer module 115 and/or the cyber threat analyst module 120 can cooperate with the one or more AI models 160 trained with machine learning on the normal pattern of life for entities in an email domain under analysis to detect, in this example, anomalous emails which are detected as outside of the usual pattern of life for each entity, such as a user, email server, etc., of the email network/domain. Likewise, the analyzer module 115 and/or the cyber threat analyst module 120 can cooperate with the one or more AI models trained with machine learning on the normal pattern of life for entities in a second domain under analysis (in this example, an IT network) to detect, in this example, anomalous network activity by user and/or devices in the network, which is detected as outside of the usual pattern of life (e.g. abnormal) for each entity, such as a user or a device, of the second domain's network under analysis.

Thus, the analyzer module 115 and/or the cyber threat analyst module 120 can be configured with one or more data analysis processes to cooperate with the one or more of the AI model(s) 160 trained with machine learning on the normal pattern of life in the system, to identify an anomaly of at least one of i) the abnormal behavior, ii) the suspicious activity, and iii) the combination of both, from one or more entities in the system. Note, other sources, such as other model breaches, can also identify at least one of i) the abnormal behavior, ii) the suspicious activity, and iii) the combination of both to trigger the investigation.

Accordingly, during this cyber threat determination process, the analyzer module 115 and/or the cyber threat analyst module 120 can also use AI classifiers that look at the features and determine a potential maliciousness based on commonality or overlap with known characteristics of malicious processes/entities. Many factors including anomalies that include unusual and suspicious behavior, and other indicators of processes and events are examined by the one or more AI models 160 trained on potential cyber threats and/or the AI classifiers looking at specific features for their malicious nature in order to make a determination of whether an individual factor and/or whether a chain of anomalies is determined to be likely malicious.

Initially, in this example of activity in an IT network analysis, the rare JA3 hash and/or rare user agent connections for this network coming from a new or unusual process are factored just like in the first wireless domain suspicious wireless signals are considered. These are quickly determined by referencing the one or more of the AI model(s) 160 trained with machine learning on the pattern of life of each device and its associated processes in the system. Next, the analyzer module 115 and/or the cyber threat analyst module 120 can have an external input to ingest threat intelligence from other devices in the network cooperating with the cyber security appliance 100. Next, the analyzer module 115 and/or the cyber threat analyst module 120 can look for other anomalies, such as model breaches, while the AI models trained on potential cyber threats can assist in examining and factoring other anomalies that have occurred over a given timeframe to see if a correlation exists between a series of two or more anomalies occurring within that time frame.

The analyzer module 115 and/or the cyber threat analyst module 120 can combine these Indicators of Compromise (e.g., unusual network JA3, unusual device JA3, . . . ) with many other weak indicators to detect the earliest signs of an emerging threat, including previously unknown threats, without using strict blacklists or hard-coded thresholds. However, the AI classifiers can also routinely look at blacklists, etc. to identify maliciousness of features looked at.

Another example of features may include a deeper analysis of endpoint data. This endpoint data may include domain metadata, which can reveal peculiarities such as one or more indicators of potentially a malicious domain (i.e., its URL). The deeper analysis may assist in confirming an analysis to determine that indeed a cyber threat has been detected. The analyzer module 115 can also look at factors of how rare the endpoint connection is, how old the endpoint is, where geographically the endpoint is located, how a security certificate associated with a communication is verified only by an endpoint device or by an external 3rd party, just to name a few additional factors. The analyzer module 115 (and similarly the cyber threat analyst module 120) can then assign weighting given to these factors in the machine learning that can be supervised based on how strongly that characteristic has been found to match up to actual malicious sites in the training.

In another AI classifier to find potentially malicious indicators, the agent analyzer data analysis process in the analyzer module 115 and/or cyber threat analyst module 120 may cooperate with the process identifier classifier to identify all of the additional factors of i) are one or more processes running independently of other processes, ii) are the one or more processes running independent are recent to this network, and iii) are the one or more processes running independent connect to the endpoint, which the endpoint is a rare connection for this network, which are referenced and compared to one or more AI models trained with machine learning on the normal behavior of the pattern of life of the system.

Note, a user agent, such as a browser, can act as a client in a network protocol used in communications within a client-server distributed computing system. In particular, the Hypertext Transfer Protocol (HTTP) identifies the client software originating (an example user agent) the request, using a user-agent header, even when the client is not operated by a user. Note, this identification can be faked, so it is only a weak indicator of the software on its own, but when compared to other observed user agents on the device, this can be used to identify possible software processes responsible for requests.

The analyzer module 115 and/or the cyber threat analyst module 120 may use the agent analyzer data analysis process that detects a potentially malicious agent previously unknown to the system to start an investigation on one or more possible cyber threat hypotheses. The determination and output of this step is what are possible cyber threats that can include or be indicated by the identified abnormal behavior and/or identified suspicious activity identified by the agent analyzer data analysis process.

In an example, the cyber threat analyst module 120 can use the agent analyzer data analysis process and the AI models(s) trained on forming and investigating hypotheses on what are a possible set of cyber threats to use the machine learning and/or set scripts to aid in forming one or more hypotheses to support or refute each hypothesis. The cyber threat analyst module 120 can cooperate with the AI models trained on forming and investigating hypotheses to form an initial set of possible hypotheses, which needs to be intelligently filtered down. The cyber threat analyst module 120 can be configured to use the one or more supervised machine learning models trained on i) agnostic examples of a past history of detection of a multitude of possible types of cyber threat hypotheses previously analyzed by human, who was a cyber security professional, ii) a behavior and input of how a plurality of human cyber security analysts make a decision and analyze a risk level regarding and a probability of a potential cyber threat, iii) steps to take to conduct an investigation start with anomaly via learning how expert humans tackle investigations into specific real and synthesized cyber threats and then the steps taken by the human cyber security professional to narrow down and identify a potential cyber threat, and iv) what type of data and metrics that were helpful to further support or refute each of the types of cyber threats, in order to determine a likelihood of whether the abnormal behavior and/or suspicious activity is either i) malicious or ii) benign.

The cyber threat analyst module 120 using AI models, scripts and/or rules based modules is configured to conduct initial investigations regarding the anomaly of interest, collected additional information to form a chain of potentially related/linked information under analysis and then form one or more hypotheses that could have this chain of information that is potentially related/linked under analysis and then gather additional information in order to refute or support each of the one or more hypotheses.

The cyber threat analyst module using AI models, scripts and/or rules-based modules is configured to conduct initial investigations regarding the anomaly of interest, collected additional information to form a chain of potentially related/linked information under analysis and then form one or more hypotheses that could have this chain of information that is potentially related/linked under analysis and then gather additional information in order to refute or support each of the one or more hypotheses.

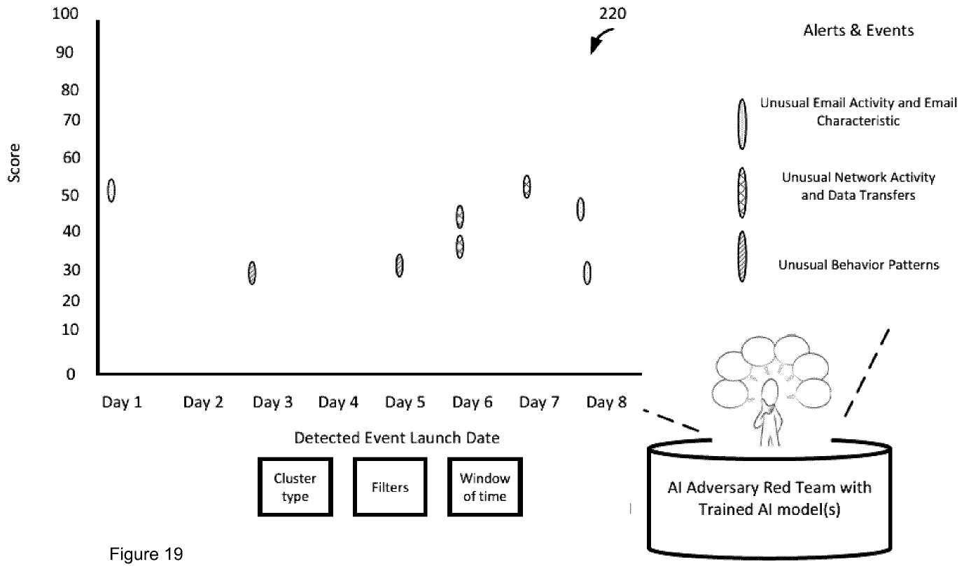

In an example, a behavioural pattern analysis of what are the unusual behaviours of the network/system/device/user under analysis by the machine learning models may be as follows. The coordinator module can tie the alerts, activities, and events from, in this example, the email domain to the alerts, activities, and events from the IT network domain. FIG. 19 illustrates a graph 220 of an embodiment of an example chain of unusual behaviour for, in this example, the email activities and IT network activities deviating from a normal pattern of life in connection with the rest of the system/network under analysis. The cyber threat analyst module and/or analyzer module can cooperate with one or more machine learning models. The one or more machine learning models are trained and otherwise configured with mathematical algorithms to infer, for the cyber-threat analysis, ‘what is possibly happening with the chain of distinct alerts, activities, and/or events, which came from the unusual pattern,’ and then assign a threat risk associated with that distinct item of the chain of alerts and/or events forming the unusual pattern. The unusual pattern can be determined by examining initially what activities/events/alerts that do not fall within the window of what is the normal pattern of life for that network/system/device/user under analysis can be analysed to determine whether that activity is unusual or suspicious. A chain of related activity that can include both unusual activity and activity within a pattern of normal life for that entity can be formed and checked against individual cyber threat hypothesis to determine whether that pattern is indicative of a behaviour of a malicious actor—human, program, or other threat. The cyber threat analyst module can go back and pull in some of the normal activities to help support or refute a possible hypothesis of whether that pattern is indicative of a behavior of a malicious actor. An example behavioral pattern included in the chain is shown in the graph over a time frame of, an example, 7 days. The cyber threat analyst module detects a chain of anomalous behavior of unusual data transfers three times, unusual characteristics in emails in the monitored system three times which seem to have some causal link to the unusual data transfers. Likewise, twice unusual credentials attempted the unusual behavior of trying to gain access to sensitive areas or malicious IP addresses and the user associated with the unusual credentials trying unusual behavior has a causal link to at least one of those three emails with unusual characteristics. Again, the cyber security appliance 100 can go back and pull in some of the normal activities to help support or refute a possible hypothesis of whether that pattern is indicative of a behaviour of a malicious actor. The analyser module can cooperate with one or more models trained on cyber threats and their behaviour to try to determine if a potential cyber threat is causing these unusual behaviours. The cyber threat analyst module can put data and entities into 1) a directed graph and nodes in that graph that are overlapping or close in distance have a good possibility of being related in some manner, 2) a vector diagram, 3) a relational database, and 4) other relational techniques that will at least be examined to assist in creating the chain of related activity connected by causal links, such as similar time, similar entity and/or type of entity involved, similar activity, etc., under analysis. If the pattern of behaviours under analysis is believed to be indicative of a malicious actor, then a score of how confident the system is in this assessment of identifying whether the unusual pattern was caused by a malicious actor is created. Next, also assigned is a threat level score or probability indicative of what level of threat does this malicious actor pose. Lastly, the cyber security appliance 100 is configurable in a user interface, by a user, enabling what type of automatic response actions, if any, the cyber security appliance 100 may take when different types of cyber threats, indicated by the pattern of behaviours under analysis, that are equal to or above a configurable level of threat posed by this malicious actor.

The autonomous response engine 140 of the cyber security system is configured to take one or more autonomous mitigation actions to mitigate the cyber threat during the cyberattack by the cyber threat. The autonomous response engine 140 is configured to reference an Artificial Intelligence model trained to track a normal pattern of life for each node of the protected system to perform an autonomous act of restricting a potentially compromised node having i) an actual indication of compromise and/or ii) merely adjacent to a known compromised node, to merely take actions that are within that node's normal pattern of life to mitigate the cyber threat. Similarly named components in the cyber security restoration engine 190 can operate and function similar to as described for the detection engine.

The chain of the individual alerts, activities, and events that form the pattern including one or more unusual or suspicious activities into a distinct item for cyber-threat analysis of that chain of distinct alerts, activities, and/or events. The cyber-threat module may reference the one or more machine learning models trained on, in this example, e-mail threats to identify similar characteristics from the individual alerts and/or events forming the distinct item made up of the chain of alerts and/or events forming the unusual pattern.

### An Assessment of the Cyber Threat in Order to Determine Appropriate Autonomous Actions, for Example, Those by the Autonomous Response Engine 140.

In the next step, the analyzer module and/or cyber threat analyst module generates one or more supported possible cyber threat hypotheses from the possible set of cyber threat hypotheses. The analyzer module generates the supporting data and details of why each individual hypothesis is supported or not. The analyzer module can also generate one or more possible cyber threat hypotheses and the supporting data and details of why they were refuted.

In general, the analyzer module cooperates with the following three sources. The analyzer module cooperates with the AI models trained on cyber threats to determine whether an anomaly such as the abnormal behavior and/or suspicious activity is either 1) malicious or 2) benign when the potential cyber threat under analysis is previously unknown to the cyber security appliance 100. The analyzer module cooperates with the AI models trained on a normal behavior of entities in the network under analysis. The analyzer module cooperates with various AI-trained classifiers. With all of these sources, when they input information that indicates a potential cyber threat that is i) severe enough to cause real harm to the network under analysis and/or ii) a close match to known cyber threats, then the analyzer module can make a final determination to confirm that a cyber threat likely exists and send that cyber threat to the assessment module to assess the threat score associated with that cyber threat. Certain model breaches will always trigger a potential cyber threat that the analyzer will compare and confirm the cyber threat.

In the next step, an assessment module with the AI classifiers is configured to cooperate with the analyzer module. The analyzer module supplies the identity of the supported possible cyber threat hypotheses from the possible set of cyber threat hypotheses to the assessment module. The assessment module with the AI classifiers cooperates with the AI model trained on possible cyber threats can make a determination on whether a cyber threat exists and what level of severity is associated with that cyber threat. The assessment module with the AI classifiers cooperates with the one or more AI models trained on possible cyber threats in order to assign a numerical assessment of a given cyber threat hypothesis that was found likely to be supported by the analyzer module with the one or more data analysis processes, via the abnormal behavior, the suspicious activity, or the collection of system data points. The assessment module with the AI classifiers output can be a score (ranked number system, probability, etc.) that a given identified process is likely a malicious process.

The assessment module with the AI classifiers can be configured to assign a numerical assessment, such as a probability, of a given cyber threat hypothesis that is supported and a threat level posed by that cyber threat hypothesis which was found likely to be supported by the analyzer module, which includes the abnormal behavior or suspicious activity as well as one or more of the collection of system data points, with the one or more AI models trained on possible cyber threats.

The cyber threat analyst module in the AI-based cyber security appliance 100 component provides an advantage over competitors' products as it reduces the time taken for cybersecurity investigations, provides an alternative to manpower for small organizations and improves detection (and remediation) capabilities within the cyber security platform.

The AI-based cyber threat analyst module performs its own computation of threat and identifies interesting network events with one or more processers. These methods of detection and identification of threat all add to the above capabilities that make the AI-based cyber threat analyst module a desirable part of the cyber security appliance 100. The AI-based cyber threat analyst module offers a method of prioritizing, which is not just a summary or highest score alert of an event evaluated by itself equals the most bad, and prevents more complex attacks from being missed because their composite parts/individual threats only produced low-level alerts.

The AI classifiers can be part of the assessment component, which scores the outputs of the analyzer module. Again, as for the other AI classifiers discussed, the AI classifier can be coded to take in multiple pieces of information about an entity, object, and/or thing and based on its training and then output a prediction about the entity, object, or thing. Given one or more inputs, the AI classifier model will try to predict the value of one or more outcomes. The AI classifiers cooperate with the range of data analysis processes that produce features for the AI classifiers. The various techniques cooperating here allow anomaly detection and assessment of a cyber threat level posed by a given anomaly; but more importantly, an overall cyber threat level posed by a series/chain of correlated anomalies under analysis.

In the next step, the formatting module can generate an output such as a printed or electronic report with the relevant data. The formatting module can cooperate with both the analyzer module and the assessment module depending on what the user wants to be reported.

The formatting module is configured to format, present a rank for, and output one or more supported possible cyber threat hypotheses from the assessment module into a formalized report, from one or more report templates populated with the data for that incident.

The formatting module is configured to format, present a rank for, and output one or more detected cyber threats from the analyzer module or from the assessment module into a formalized report, from one or more report templates populated with the data for that incident. Many different types of formalized report templates exist to be populated with data and can be outputted in an easily understandable format for a human user's consumption.

The formalized report on the template is outputted for a human user's consumption in a medium of any of 1) printable report, 2) presented digitally on a user interface, 3) in a machine readable format for further use in machine-learning reinforcement and refinement, or 4) any combination of the three. The formatting module is further configured to generate a textual write up of an incident report in the formalized report for a wide range of breaches of normal behavior, used by the AI models trained with machine learning on the normal behavior of the system, based on analyzing previous reports with one or more models trained with machine learning on assessing and populating relevant data into the incident report corresponding to each possible cyber threat. The formatting module can generate a threat incident report in the formalized report from a multitude of a dynamic human-supplied and/or machine created templates corresponding to different types of cyber threats, each template corresponding to different types of cyber threats that vary in format, style, and standard fields in the multitude of templates. The formatting module can populate a given template with relevant data, graphs, or other information as appropriate in various specified fields, along with a ranking of a likelihood of whether that hypothesis cyber threat is supported and its threat severity level for each of the supported cyber threat hypotheses, and then output the formatted threat incident report with the ranking of each supported cyber threat hypothesis, which is presented digitally on the user interface and/or printed as the printable report.

In the next step, the assessment module with the AI classifiers, once armed with the knowledge that malicious activity is likely occurring/is associated with a given process from the analyzer module, then cooperates with the autonomous response engine 140 to take an autonomous action such as i) deny access in or out of the device or the network and/or ii) shutdown activities involving a detected malicious agent.

The autonomous response engine 140, rather than a human taking an action, can be configured to cause one or more rapid autonomous mitigation actions to be taken to counter the cyber threat. A user interface for the response module can program the autonomous response engine 140 i) to merely make a suggested response to take to counter the cyber threat that will be presented on a display screen and/or sent by a notice to an administrator for explicit authorization when the cyber threat is detected or ii) to autonomously take a response to counter the cyber threat without a need for a human to approve the response when the cyber threat is detected. The autonomous response engine 140 will then send a notice of the autonomous response as well as display the autonomous response taken on the display screen. Example autonomous responses may include cut off connections, shutdown devices, change the privileges of users, delete and remove malicious links in emails, slow down a transfer rate, and other autonomous actions against the devices and/or users. The autonomous response engine 140 uses one or more Artificial Intelligence models that are configured to intelligently work with other third-party defense systems in that customer's network against threats. The autonomous response engine 140 can send its own protocol commands to devices and/or take actions on its own. In addition, the autonomous response engine 140 uses the one or more Artificial Intelligence models to orchestrate with other third-party defense systems to create a unified defense response against a detected threat within or external to that customer's network. The autonomous response engine 140 can be an autonomous self-learning response coordinator that is trained specifically to control and reconfigure the actions of traditional legacy computer defenses (e.g., firewalls, switches, proxy servers, etc.) to contain threats propagated by, or enabled by, networks and the internet. The cyber threat module can cooperate with the autonomous response engine 140 to cause one or more autonomous actions in response to be taken to counter the cyber threat, improves computing devices in the system by limiting an impact of the cyber threat from consuming unauthorized CPU cycles, memory space, and power consumption in the computing devices via responding to the cyber threat without waiting for some human intervention.

The trigger module, analyzer module, assessment module, and formatting module cooperate to improve the analysis and formalized report generation with less repetition to consume CPU cycles with greater efficiency than humans repetitively going through these steps and re-duplicating steps to filter and rank the one or more supported possible cyber threat hypotheses from the possible set of cyber threat hypotheses.

Again, the multiple (e.g., four) Artificial Intelligence-based engines have communication hooks in between them to exchange a significant amount of behavioral metrics including data between the multiple Artificial Intelligence-based engines to work in together to provide an overall cyber threat response. The AI adaptive incident response loop has interaction and orchestration between the multiple (four) self-learning AI components, each trained and focused on their individual machine-learned tasks of i) detecting a cyber threat, ii) how to conduct a simulation and make the prediction about a cyberattack, iii) how to make and what types of autonomous mitigation responses can be made in response to a cyberattack and iv) what level of restrictions are needed and how to invoke restoration actions to restore nodes in the system being protected while still mitigating effects of the cyberattack. The Artificial Intelligence in each of the engines trained and focused on performing their corresponding machine-learned tasks as well as the orchestration between the Artificial Intelligence-based engines drive the exchange to make them work in together against a cyberattack by the cyber threat (e.g., malicious actor). The intelligent orchestration component facilitates the multiple example stages of the Artificial Intelligence augmented and adaptive interactive response loop between these four Artificial Intelligence-based engines.

Referring again to FIG. 15, the cyber security appliance 100 provide an interactive Artificial Intelligence-based response loop between the multiple Artificial Intelligence-based engines working in tandem to provide an overall cyber threat response. The cyber-attack simulator after running the Artificial Intelligence-based simulations communicates to the autonomous response engine 140 the locations where it could block the likely and/dangerous next moves by the attacker. The Artificial Intelligence in the autonomous response engine 140 analyzes the simulation results and grabs any additional information needed to decide what nodes need autonomous actions and what mitigation actions to take to each node that is compromised and potentially its neighboring nodes. The Artificial Intelligence in the autonomous response engine 140 reasons and takes action. The AI engines also update the report visible to the human cyber security team.

This interactive Artificial Intelligence-based response loop between the multiple Artificial Intelligence-based engines working together continues on. The intelligent orchestration component uses unsupervised machine learning algorithms to self-learn from previous cyber threat incidents (and their aftermath) on tasks such as how the response went, what worked, what did not, how long things took and how this compared to previous occasions and to expectations, and then uses this information to adjust future incident response expectations and priorities. The intelligent orchestration component can use action success/completion and time taken as measures of improvement. Likewise, the restoration engine can use unsupervised machine learning algorithms to self-learn from previous cyber threat incidents to get better at healing the system being protected to mitigate the cyber threat while minimizing an impact on the system being protected. Likewise, the cyber security restoration engine 190 can use one or more unsupervised machine learning algorithms, as a self-learning entity, to have an ability to learn how to restore the one or more nodes in the graph of the protected system back to the trusted operational state while still mitigating against the cyber threat so the cyber security restoration engine 190 gets better over time of a deployment of the cyber security restoration engine 190 by learning from previous restoration attempts (e.g. action success/completion and time taken as measures, action effectiveness as a measure, etc., as well as including or adapting changes to previous recommendations made by the human security team.

The cyber threat detection engine, the autonomous response engine 140, the cyber-attack simulator all perform their machine-learned task and send inputs to each other to assist in determining what nodes are impacted, what cyber threat is causing the problems, and how the cyberattack likely occurred and will progress based upon possible mitigation and restoration actions taken so that the restoration engine can rely on the determinations by the Artificial Intelligence in those AI-based engines to give the restoration engine a fantastic starting point for figuring out what is the system being protected is trying to recover from and then a best way to restore the nodes in the system.

There are four discrete AI-based engines working to achieve aims with their own machine learning approaches. Each separate AI contributes data that has been processed intelligently through machine learning approaches and then hands over the processed behavioral metrics to another AI engine which then performs its own individualized machine-learned task.

The cyber-attack simulator in conducting simulations can use the cyber threat analyst module with external data input (e.g., crowdstrike) and cooperate with the detection engine to identify an infected patient zero and additional devices actually compromised and/or directly linked to devices actually compromised in need of remediation. The linked devices or the activity may not be directly visible to the detection engine alone and the external data input fills in the big picture. The cyber security restoration engine 190 to restore the protected system can potentially use the external data input that the system is receiving from third party integrations (e.g., from host-based agents from 3rd party vendors, antivirus and-based testing antivirus, etc. to identify patient zero of the attack, identify, where the attack has happened and is happening, identify devices that the system reasonably believes are linked to the compromised entity, and recommend remediation or perform remediation via AI alone, and/or AI in combination with human assistance. The cyber security restoration engine 190 can restore the protected system back to a state before a compromise (e.g., abnormalities started) by a cyber threat occurred to the protected system. The cyber security restoration engine 190 restores nodes in the protected system to cyberattacks in progress—so heals in real time, as an attack happens, as well as can assist in healing after an attack has taken place.

The trusted operational state of a node can be an operational state for a date and time before the earliest detection of a possible compromise of a node in the graph (device and/or user account) plus a threshold buffer amount of time.

In an example, the detection engine can use historic IaaS data on virtual resource usage to identify errant virtual resources and the autonomous response engine 140 to spin down those resources or disable overactive microservices like lambdas. In another example, the detection engine can use historic IaaS data on virtual resource usage to understand when a client is undergoing some kind of DDOS and the autonomous response engine 140 acts to do scaling to handle the load until the overload is over. The restoration engine can recommend controlling the scaling when the system understands deliberate overloading of traffic is occurring and then bringing that scaling back down again to assist their service architectures to deal with situations when some cyber threat is trying to overload those systems to bring that customer down.

In another example, the cyber security restoration engine 190 to restore the protected system can use historic source codebase information and modelling from the AI models in the detection engine for development to revert commits and code changes that potentially introduce bad or compromised code. The cyber security restoration engine 190 to restore the protected system can also use historic records of a source code database information to find out when during the development of a product that the cyber-attack occurred on the source code in order to restore the source code back to the state before the compromise occurred, as well as use historic code base analysis and understanding to identify supply chain and products vulnerable to bad code/compromised code and sending an update package/at least a notice to revert those products and further prevent the source code vulnerabilities from trickling down the supply chains from the vendor to the end user. Once file data of a cyber threat is identified, then that file data and its characteristics are captured in an inoculation package and then cascade that file information to each cyber security appliance in the fleet of cyber security appliances, and quarantine the identical and very similar files in order to remove them from all of the environments before anything can spread even more than it has via immediate remediation and also using the system's own inoculation data.

In an example, the autonomous response engine 140 can stop a device that is infected from connecting to other nodes. In addition, the autonomous response engine 140 can restrict reading and writing traffic and/or types of data/information being communicated in that traffic to restrict traffic movement and process activity to nodes close to an entity that the system thinks is performing erroneously or infected.

Referring to FIG. 13, the autonomous response engine 140 is configured to use one or more Application Programming Interfaces to translate desired mitigation actions for nodes (devices, user accounts, etc.) into a specific language and syntax utilized by that device, user account, etc. from potentially multiple different vendors being protected in order to send the commands and other information to cause the desired mitigation actions to change, for example, a behavior of a detected threat of a user and/or a device acting abnormal to the normal pattern of life. The selected mitigation actions on the selected nodes minimize an impact on other parts of the system being protected (e.g., devices and users) that are i) currently active in the system being protected and ii) that are not in breach of being outside the normal behavior benchmark. The autonomous response engine 140 can have a discovery module to i) discover capabilities of each node being protected device and the other cyber security devices (e.g., firewalls) in the system being protected and ii) discover mitigation actions they can take to counter and/or contain the detected threat to the system being protected, as well as iii) discover the communications needed to initiate those mitigation actions.

For example, the autonomous response engine 140 cooperates and coordinates with an example set of network capabilities of various network devices. The network devices may have various capabilities such as identity management including setting user permissions, network security controls, firewalls denying or granting access to various ports, encryption capabilities, centralize logging, antivirus anti-malware software quarantine and immunization, patch management, etc., and also freeze any similar, for example, network activity, etc. triggering the harmful activity on the system being protected.

Accordingly, the autonomous response engine 140 will take an autonomous mitigation action to, for example, shutdown the device or user account, block login failures, perform file modifications, block network connections, restrict the transmission of certain types of data, restrict a data transmission rate, remove or restrict user permissions, etc. The autonomous response engine 140 for an email system could initiate example mitigation actions to either remedy or neutralize the tracking link, when determined to be the suspicious covert tracking link, while not stopping every email entering the email domain with a tracking link, or hold the email communication entirely if the covert tracking link is highly suspicious, and also freeze any similar, for example, email activity triggering the harmful activity on the system being protected.

The autonomous response engine 140 has a default set of autonomous mitigation actions shown on its user interface that it knows how to perform when the different types of cyber threats are equal to or above a user configurable threshold posed by this type of cyber threat. The autonomous response engine 140 is also configurable in its user interface to allow the user to augment and change what type of automatic mitigation actions, if any, the autonomous response engine 140 may take when different types of cyber threats that are equal to or above the configurable level of threat posed by a cyber threat.

The autonomous response engine 140 can also reference its artificial intelligence trained to perform mitigation actions. Again, the autonomous response engine 140 has an administrative tool in its user interface to program/set what autonomous mitigation actions the autonomous response engine 140 can take, including types of mitigation actions and specific mitigation actions the autonomous response engine 140 is capable of, when the cyber-threat module in the detection engine indicates the threat risk parameter is equal to or above the actionable threshold, selectable by the cyber professional. The cyber professional can also indicate what types of mitigation actions can be performed for different users and parts of the system as well as what actions need the cyber professional to approve. Again, the autonomous response engine 140 can also reference a default library of mitigation actions, types of mitigation actions and specific mitigation actions the autonomous response engine 140 is capable of on a particular node.

Referring to FIG. 16, the cyber-attack simulator 105 using Artificial Intelligence-based simulations is communicatively coupled to a cyber security appliance 100, an open source (OS) database server 790, an email system 796, one or more endpoint computing devices 791A-B, and an IT network system 792 with one or more entities, over one or more networks 791/792 in the system being protected.

The cyber-attack simulator 105 with Artificial Intelligence-based simulations is configured to integrate with the cyber security appliance 100 and cooperate with components within the cyber security appliance 100 installed and protecting the network from cyber threats by making use of outputs, data collected, and functionality from two or more of a data store, other modules, and one or more AI models already existing in the cyber security appliance 100.

The cyber-attack simulator 105 may include a cyber threat generator module to generate many different types of cyber threats with the past historical attack patterns to attack the simulated system to be generated by the simulated attack module 750 that will digitally/virtually replicate the system being protected, such as a phishing email generator configured to generate one or more automated phishing emails to pentest the email defenses and/or the network defenses provided by the cyber security appliance 100. For example, the system being protected can be an email system and then the phishing email generator may be configured to cooperate with the trained AI models to customize the automated phishing emails based on the identified data points of the organization and its entities.

The email module and network module may use a vulnerability tracking module to track and profile, for example, versions of software and a state of patches and/or updates compared to a latest patch and/or update of the software resident on devices in the system/network. The vulnerability tracking module can supply results of the comparison of the version of software as an actual detected vulnerability for each particular node in the system being protected, which is utilized by the node exposure score generator and the cyber-attack simulator 105 with Artificial Intelligence-based simulations in calculating 1) the spread of a cyber threat and 2) a prioritization of remediation actions on a particular node compared to the other network nodes with actual detected vulnerabilities. The node exposure score generator is configured to also factor in whether the particular node is exposed to direct contact by an entity generating the cyber threat (when the threat is controlled from a location external to the system e.g., network) or the particular node is downstream of a node exposed to direct contact by the entity generating the cyber threat external to the network.

The node exposure score generator and the simulated attack module 750 in the cyber-attack simulator 105 cooperate to run the one or more hypothetical simulations of an actual detected cyber threat incident and/or a hypothetical cyberattack incident to calculate the node paths of least resistance in the virtualized instance/modeled instance of the system being protected. The progress through the node path(s) of least resistance through the system being protected are plotted through the various simulated instances of components of the graph of the system being protected until reaching a suspected end goal of the cyber-attack scenario, all based on historic knowledge of connectivity and behavior patterns of users and devices within the system under analysis. The simulated attack module 750, via a simulator and/or a virtual network clone creator, can be programmed to model and work out the key paths and devices in the system (e.g., a network, with its nets and subnets) via initially mapping out the system being protected and querying the cyber security appliance on specific's known about the system being protected by the cyber security appliance 100. The simulated attack module 750 is configured to search and query, two or more of i) a data store, ii) modules in the detection engine, and iii) the one or more Artificial Intelligence (AI) models making up the cyber security appliance 100 protecting the actual network under analysis from cyber threats, on what, i) the data store, ii) the modules, and iii) the one or more AI models in the cyber security appliance 100, already know about the nodes of the system, under analysis to create the graph of nodes of the system being protected. Thus, the cyber-attack simulator 105 with Artificial Intelligence-based simulations is configured to construct the graph of the virtualized version of the system from knowledge known and stored by modules, a data store, and one or more AI models of a cyber security appliance 100 protecting an actual network under analysis. The knowledge known and stored is obtained at least from ingested traffic from the actual system under analysis. Thus, the virtualized system, and its node components/accounts connecting to the network, being tested during the simulation are up to date and accurate for the time the actual system under analysis is being tested and simulated because the cyber-attack simulator 105 with Artificial Intelligence-based simulations is configured to obtain actual network data collected by two or more of 1) modules, 2) a data store, and 3) one or more AI models of a cyber security appliance protecting the actual network under analysis from cyber threats. The simulated attack module 750 will make a model incorporating the actual data of the system through the simulated versions of the nodes making up that system for running simulations on the simulator. Again, a similar approach is taken when the simulated attack module 750 uses a clone creator to spin up and create a virtual clone of the system being protected with virtual machines in the cloud.

The cyber-attack simulator 105 with Artificial Intelligence-based simulations is configured to simulate the compromise of a spread of the cyber threat being simulated in the simulated cyber-attack scenario, based on historical and/or similar cyber threat attack patterns, between the devices connected to the virtualized network, via a calculation on an ease of transmission of the cyber threat algorithm, from 1) an originally compromised node by the cyber threat, 2) through to other virtualized/simulated instances of components of the virtualized network, 3) until reaching a suspected end goal of the cyber-attack scenario, including key network devices. The cyber-attack simulator 105 with Artificial Intelligence-based simulations also calculates how likely it would be for the cyber-attack to spread to achieve either of 1) a programmable end goal of that cyber-attack scenario set by a user, or 2) set by default an end goal scripted into the selected cyber-attack scenario.

The email module and the network module can include a profile manager module. The profile manager module is configured to maintain a profile tag on all of the devices connecting to the actual system/network under analysis based on their behavior and security characteristics and then supply the profile tag for the devices connecting to the virtualized instance of the system/network when the construction of the graph occurs. The profile manager module is configured to maintain a profile tag for each device before the simulation is carried out; and thus, eliminates a need to search and query for known data about each device being simulated during the simulation. This also assists in running multiple simulations of the cyberattack in parallel.

The cyber-attack simulator 105 with Artificial Intelligence-based simulations module is configured to construct the graph of the virtualized system, e.g. a network with its nets and subnets, where two or more of the devices connecting to the virtualized network are assigned with different weighting resistances to malicious compromise from the cyber-attack being simulated in the simulated cyber-attack scenario based on the actual cyber-attack on the virtualized instance of the network and their node vulnerability score. In addition to a weighting resistance to the cyberattack, the calculations in the model for the simulated attack module 750 factor in the knowledge of a layout and connection pattern of each particular network device in a network, an amount of connections and/or hops to other network devices in the network, how important a particular device (a key importance) determined by the function of that network device, the user(s) associated with that network device, and the location of the device within the network. Note, multiple simulations can be conducted in parallel by the orchestration module. The simulations can occur on a periodic regular basis to pentest the cyber security of the system and/or in response to a detected ongoing cyberattack in order to get ahead of the ongoing cyberattack and predict its likely future moves. Again, the graph of the virtualize instance of the system is created with two or more of 1) known characteristics of the network itself, 2) pathway connections between devices on that network, 3) security features and credentials of devices and/or their associated users, and 4) behavioral characteristics of the devices and/or their associated users connecting to that network, which all of this information is obtained from what was already know about the network from the cyber security appliance.

During an ongoing cyberattack, the simulated attack module 750 is configured to run the one or more hypothetical simulations of the detected cyber threat incident and feed details of a detected incident by a cyber threat module in the detection engine into the collections module of the cyber-attack simulator 105 using Artificial Intelligence-based simulations. The simulated attack module 750 is configured to run one or more hypothetical simulations of that detected incident in order to predict and assist in the triggering an autonomous response by the autonomous response engine 140 and then restoration by the restoration engine to the detected incident.

The simulated attack module 750 ingests the information for the purposes of modeling and simulating a potential cyberattacks against the network and routes that an attacker would take through the network. The simulated attack module 750 can construct the graph of nodes with information to i) understand an importance of network nodes in the network compared to other network nodes in the network, and ii) to determine key pathways within the network and vulnerable network nodes in the network that a cyber-attack would use during the cyber-attack, via modeling the cyber-attack on at least one of 1) a simulated device version and 2) a virtual device version of the system being protected under analysis. Correspondingly, the calculated likelihood of the compromise and timeframes for the spread of the cyberattack is tailored and accurate to each actual device/user account (e.g., node) being simulated in the system because the cyber-attack scenario is based upon security credentials and behavior characteristics from actual traffic data fed to the modules, data store, and AI models of the cyber security appliance.

The cyber-attack simulator 105 with its Artificial Intelligence trained on how to conduct and perform cyberattack in a simulation in either a simulator or in a clone creator spinning up virtual instances on virtual machines will take a sequence of actions and then evaluate the actual impact after each action in the sequence, in order to yield a best possible result to contain/mitigate the detected threat while minimizing the impact on other network devices and users that are i) currently active and ii) not in breach, from different possible actions to take. Again, multiple simulations can be run in parallel so that the different sequences of mitigation actions and restoration actions can be evaluated essentially simultaneously. The cyber-attack simulator 105 with Artificial Intelligence-based simulations in the cyber-attack simulator 105 is configured to use one or more mathematical functions to generate a score and/or likelihood for each of the possible actions and/or sequence of multiple possible actions that can be taken in order to determine which set of actions to choose among many possible actions to initiate. The one or more possible actions to take and their calculated scores can be stacked against each other to factor 1) a likelihood of containing the detected threat acting abnormal with each possible set of actions, 2) a severity level of the detected threat to the network, and 3) the impact of taking each possible set of actions i) on users and ii) on devices currently active in the network not acting abnormal to the normal behavior of the network, and then communicate with the cyber threat detection engine, the autonomous response engine 140, and the cyber-security restoration engine 190, respectively, to initiate the chosen set of actions to cause a best targeted change of the behavior of the detected threat acting abnormal to the normal pattern of life on the network while minimizing the impact on other network devices and users that are i) currently active and ii) not in breach of being outside the normal behavior benchmark. The cyber-attack simulator cooperates with the AI models modelling a normal pattern of life for entities/nodes in the system being protected.

The simulated attack module 750 is programmed itself and can cooperate with the artificial intelligence in the restoration engine to factor an intelligent prioritization of remediation actions and which nodes (e.g., devices and user accounts) in the simulated instance of the system being protected should have a priority compared to other nodes. This can also be reported out to assist in allocating human security team personnel resources that need human or human approval to restore the nodes based on results of the one or more hypothetical simulations of the detected incident.

Note, the cyber attack simulator 105, when doing attack path modelling, does not need to not calculate every theoretically possible path from the virtualized instance of the source device to the end goal of the cyber-attack scenario but rather a set of the most likely paths, each time a hop is made from one node in the virtualized network to another device in the virtualized network, in order to reduce an amount of computing cycles needed by the one or more processing units as well as an amount of memory storage needed in the one or more non-transitory storage mediums.

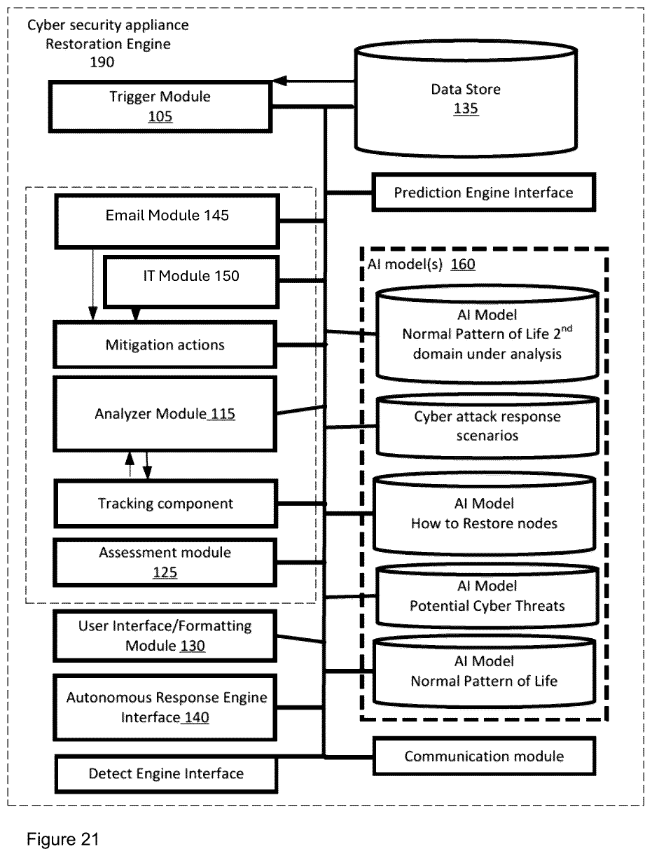

FIG. 21 illustrates a block diagram of an embodiment of the AI-based cyber security appliance 100 with the cyber security restoration engine 190 and other Artificial Intelligence-based engines plugging in as an appliance platform to protect a system. The probes and detectors monitor, in this example, email activity and IT network activity to feed this data to determine what is occurring in each domain individually to their respective modules configured and trained to understand that domain's information as well as correlate causal links between these activities in these domains to supply this input into the modules of the cyber security appliance 100. The network can include various computing devices such as desktop units, laptop units, smart phones, firewalls, network switches, routers, servers, databases, Internet gateways, etc.

Referring back to FIG. 13, a computer system within a building, can use the cyber security appliance 100 to detect and thereby attempt to prevent threats to computing devices within its bounds. In this exemplary embodiment of the cyber security appliance 100 with the multiple Artificial Intelligence-based engines is implemented on a computer. The computer has the electronic hardware, modules, models, and various software processes of the cyber security appliance 100; and therefore, runs threat detection for detecting threats to the first computer system. As such, the computer system includes one or more processors arranged to run the steps of the process described herein, memory storage components required to store information related to the running of the process, as well as a network interface for collecting the required information for the probes and other sensors collecting data from the network under analysis.

The cyber security appliance 100 in the computer builds and maintains a dynamic, ever-changing model of the ‘normal behavior’ of each user and machine within the system. The approach is based on Bayesian mathematics, and monitors all interactions, events, and communications within the system—which computer is talking to which, files that have been created, networks that are being accessed.

For example, a second computer is based in a company's San Francisco office and operated by a marketing employee who regularly accesses the marketing network, usually communicates with machines in the company's U.K. office in second computer system 40 between 9.30 AM and midday, and is active from about 8:30 AM until 6 PM.

The same employee virtually never accesses the employee time sheets, very rarely connects to the company's Atlanta network and has no dealings in South-East Asia. The security appliance takes all the information that is available relating to this employee and establishes a ‘pattern of life’ for that person and the devices used by that person in that system, which is dynamically updated as more information is gathered. The model of the normal pattern of life for an entity in the network under analysis is used as a moving benchmark, allowing the cyber security appliance 100 to spot behavior on a system that seems to fall outside of this normal pattern of life, and flags this behavior as anomalous, requiring further investigation and/or autonomous action.

The cyber security appliance 100 is built to deal with the fact that today's attackers are getting stealthier, and an attacker/malicious agent may be ‘hiding’ in a system to ensure that they avoid raising suspicion in an end user, such as by slowing their machine down. The Artificial Intelligence model(s) in the cyber security appliance 100 builds a sophisticated ‘pattern of life’—that understands what represents normality for every person, device, and network activity in the system being protected by the cyber security appliance 100.

The self-learning algorithms in the AI can, for example, understand each node's (user account, device, etc.) in an organization's normal patterns of life in about a week, and grows more bespoke with every passing minute. Conventional AI typically relies solely on identifying threats based on historical attack data and reported techniques, requiring data to be cleansed, labelled, and moved to a centralized repository. The detection engine self-learning AI can learn “on the job” from real-world data occurring in the system and constantly evolves its understanding as the system's environment changes. The Artificial Intelligence can use machine learning algorithms to analyze patterns and ‘learn’ what is the ‘normal behavior’ of the network by analyzing data on the activity on the network at the device and employee level. The unsupervised machine learning does not need humans to supervise the learning in the model but rather discovers hidden patterns or data groupings without the need for human intervention. The unsupervised machine learning discovers the patterns and related information using the unlabeled data monitored in the system itself. Unsupervised learning algorithms can include clustering, anomaly detection, neural networks, etc. Unsupervised Learning can break down features of what it is analyzing (e.g., a network node of a device or user account), which can be useful for categorization, and then identify what else has similar or overlapping feature sets matching to what it is analyzing.

The cyber security appliance 100 can use unsupervised machine learning to works things out without pre-defined labels. In the case of sorting a series of different entities, such as animals, the system analyzes the information and works out the different classes of animals. This allows the system to handle the unexpected and embrace uncertainty when new entities and classes are examined. The modules and models of the cyber security appliance 100 do not always know what they are looking for but can independently classify data and detect compelling patterns.

The cyber security appliance's 100 unsupervised machine learning methods do not require training data with pre-defined labels. Instead, they are able to identify key patterns and trends in the data, without the need for human input. The advantage of unsupervised learning in this system is that it allows computers to go beyond what their programmers already know and discover previously unknown relationships. The unsupervised machine learning methods can use a probabilistic approach based on a Bayesian framework. The machine learning allows the cyber security appliance 100 to integrate a huge number of weak indicators/low threat values by themselves of potentially anomalous network behavior to produce a single clear overall measure of these correlated anomalies to determine how likely a network device is to be compromised. This probabilistic mathematical approach provides an ability to understand important information, amid the noise of the network—even when it does not know what it is looking for.

The models in the cyber security appliance 100 can use a Recursive Bayesian Estimation to combine these multiple analyzes of different measures of network behavior to generate a single overall/comprehensive picture of the state of each device, the cyber security appliance 100 takes advantage of the power of Recursive Bayesian Estimation (RBE) via an implementation of the Bayes filter.

Using RBE, the cyber security appliance 100's AI models are able to constantly adapt themselves, in a computationally efficient manner, as new information becomes available to the system. The cyber security appliance 100's AI models continually recalculate threat levels in the light of new evidence, identifying changing attack behaviors where conventional signature-based methods fall down.

Training a model can be accomplished by having the model learn good values for all of the weights and the bias for labeled examples created by the system, and in this case, starting with no labels initially. A goal of the training of the model can be to find a set of weights and biases that have low loss, on average, across all examples.

The AI classifier can receive supervised machine learning with a labeled data set to learn to perform their task as discussed herein. An anomaly detection technique that can be used is supervised anomaly detection that requires a data set that has been labeled as “normal” and “abnormal” and involves training a classifier. Another anomaly detection technique that can be used is an unsupervised anomaly detection that detects anomalies in an unlabeled test data set under the assumption that the majority of the instances in the data set are normal, by looking for instances that seem to fit least to the remainder of the data set. The model representing normal behavior from a given normal training data set can detect anomalies by establishing the normal pattern and then test the likelihood of a test instance under analysis to be generated by the model. Anomaly detection can identify rare items, events or observations which raise suspicions by differing significantly from the majority of the data, which includes rare objects as well as things like unexpected bursts in activity.

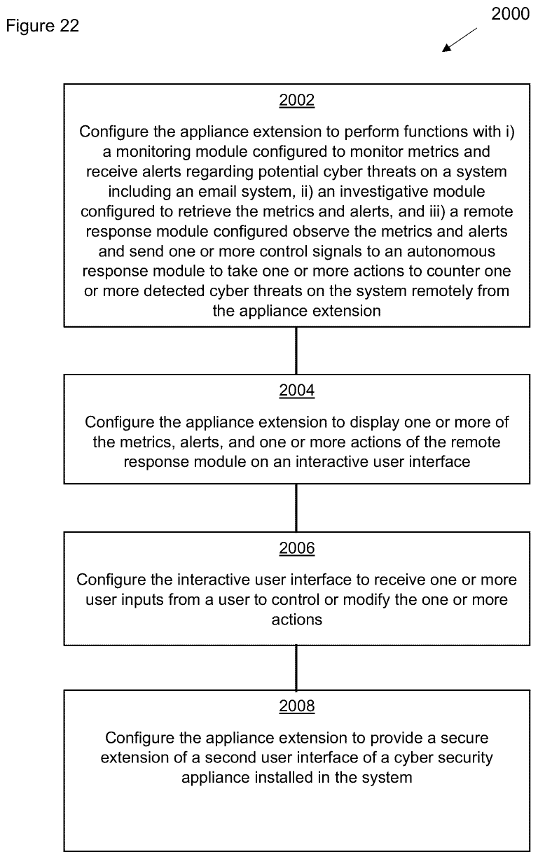

FIG. 22 is a flowchart of a method 2000 to implement a technique described herein. The method may be computer-implemented by an appliance extension according to embodiments described herein, for example as depicted by FIG. 1.

Method 2000 comprises, at block 2002, configuring the appliance extension to perform functions with i) a monitoring module configured to monitor metrics and receive alerts regarding potential cyber threats on a system including an email system, ii) an investigative module configured to retrieve the metrics and alerts, and iii) a remote response module configured observe the metrics and alerts and send one or more control signals to an autonomous response module to take one or more actions to counter one or more detected cyber threats on the system remotely from the appliance extension.

The method further comprises, at block 2004, configuring the appliance extension to display one or more of the metrics, alerts, and one or more actions of the remote response module on an interactive user interface.

The method further comprises, at block 2006, configuring the interactive user interface to receive one or more user inputs from a user to control or modify the one or more actions.

The method further comprises, at block 2008, configuring the appliance extension to provide a secure extension of a second user interface of a cyber security appliance installed in the system.

Some embodiments of the method 2000 will now be described.

In some embodiments, the method 2000 further comprises configuring the appliance extension to display an interactive contextualised summary of one or more of the metrics, alerts, and one or more actions on the interactive user interface in a simplified human-readable format based on a compilation of data from one or more of: the monitoring module, the investigative module, the remote response module, and additional data from the system.

In some embodiments, the one or more user inputs to control or modify the one or more actions of the autonomous response module comprises: approving one or more actions of the autonomous response module to counter the detected cyber threats; preventing the autonomous response module from performing the one or more actions; modifying the one or more actions of the autonomous response module to counter the detected cyber threats.

In some embodiments, the method 2000 further comprises: configuring the appliance extension to, in response to a user input, retrieve and display additional contextual information related to one or more of the metrics, the alerts, the one or more actions, or the detected cyber threat on the interactive user interface to allow the user to further investigate the detected cyber threats; and configuring the interactive user interface to receive comments input by the user, the comments being associated with one or more of the metrics, alerts, or one or more actions.

In some embodiments, the method 2000 further comprises configuring the appliance extension to: perform functions with a cyberattack simulation module configured to perform a machine-learned task of initiating and monitoring a cyberattack simulation on the system; display, on the interactive user interface, metrics related to the progression of the simulated cyberattack, and receive one or more user inputs via the interactive user interface to modify the simulated cyberattack; and send one or more control signals to the cyberattack simulation module to modify the simulated cyberattack.

In some embodiments, the method 2000 further comprises: configuring the appliance extension to perform functions with a restoration module configured to perform a machine-learned task of remediating the system back to a trusted operational state after a cyber threat is countered; configuring the appliance extension to receive one or more recommended restoration actions from the restoration module and display the restoration actions on the interactive user interface; configuring the interactive user interface to receive one or more inputs to approve, prevent, or modify the recommended restoration actions; and configuring the appliance extension to send one or more control signals to control the restoration module to perform the one or more recommended restoration actions, perform the modified recommended restoration actions, or prevent performance of the recommended restoration actions.

In some embodiments, the method 2000 further comprises configuring the appliance extension to: receive a proactive threat notification (PTN) from an operator on the system, the PTN being indicative that a cyber threat has been detected on the system based on information from the monitoring module and the investigative module; display, on the interactive user interface, information related to the potential cyber threat associated with the PTN and a recommended action to counter the potential cyber threat; receive one or more user inputs to approve, prevent, or modify the recommended action; and send one or more control signals to control the autonomous response module to perform the recommended action, perform the modified recommended action, or prevent performance of the recommended action.

In some embodiments, wherein the monitoring module and investigative module are further configured to respectively monitor and retrieve additional metrics based at least in part on one or more of: third-party data and open source intelligence to identify potential cyber threats, and the method 2000 further comprises: configuring the appliance extension to receive a common vulnerabilities and exposures (CVE) notification from the investigative module based on the additional metrics, the CVE being indicative that a potential cyber threat putting the system at risk has been identified, wherein the CVE notification comprises information indicating one or more assets on the system which are at risk from the potential cyber threat.

In some embodiments, the appliance extension is a mobile application installed on a smart mobile device that needs to be registered, and the method 2000 further comprises: configuring the registered mobile application on the smart device and the cyber security appliance to communicate securely via a backend server, via at least 1) using a secure protocol and 2) requiring a need to authenticate communications with a unique and verifiable signature, not a public Internet Protocol IP address, from i) an instance of the registered mobile application, ii) the cyber security appliance installed in the system, or iii) unique signatures of both the cyber security appliance and the instance of the registered mobile application.

The method may also be implemented by a non-transitory computer readable medium comprising computer readable code operable, when executed by one or more processing apparatuses in a computer system to instruct a computing device to perform the method according to techniques described herein.

The methods and systems shown in the Figures and discussed in the text herein can be coded to be performed, at least in part, by one or more processing components with any portions of software stored in an executable format on a computer readable medium. Thus, any portions of the method, apparatus and system implemented as software can be stored in one or more non-transitory memory storage devices in an executable format to be executed by one or more processors. The computer readable medium may be non-transitory and does not include radio or other carrier waves. The computer readable medium could be, for example, a physical computer readable medium such as semiconductor memory or solid-state memory, magnetic tape, a removable computer diskette, a random-access memory (RAM), a read-only memory (ROM), a rigid magnetic disc, and an optical disk, such as a CD-ROM, CD-R/W or DVD. The various methods described above may also be implemented by a computer program product. The computer program product may include computer code arranged to instruct a computer to perform the functions of one or more of the various methods described above. The computer program and/or the code for performing such methods may be provided to an apparatus, such as a computer, on a computer readable medium or computer program product. For the computer program product, a transitory computer readable medium may include radio or other carrier waves.

A computing system can be, wholly or partially, part of one or more of the server or client computing devices in accordance with some embodiments. Components of the computing system can include, but are not limited to, a processing unit having one or more processing cores, a system memory, and a system bus that couples various system components including the system memory to the processing unit.

### Computing Devices

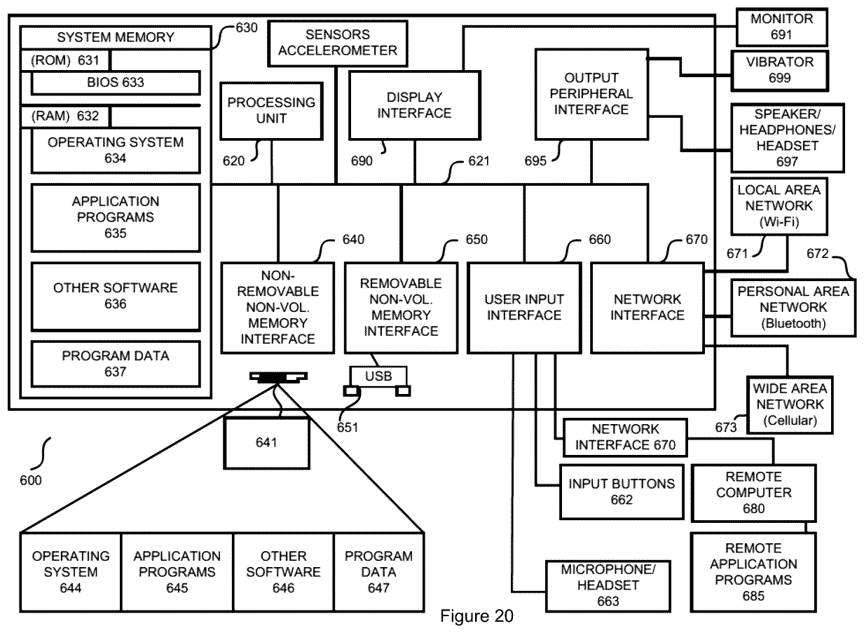

FIG. 20 illustrates a block diagram of an embodiment of one or more computing devices that can be a part of the Artificial Intelligence-based cyber security system including the multiple Artificial Intelligence-based engines discussed herein. As discussed, the appliance extension is configured to provide a secure extension of a second user interface of the cyber security appliance installed in the system.

The computing device may include one or more processors or processing units 620 to execute instructions, one or more memories 630-632 to store information, one or more data input components 660-663 to receive data input from a user of the computing device 600, one or more modules that include the management module, a network interface communication circuit 670 to establish a communication link to communicate with other computing devices external to the computing device, one or more sensors where an output from the sensors is used for sensing a specific triggering condition and then correspondingly generating one or more preprogrammed actions, a display screen 691 to display at least some of the information stored in the one or more memories 630-632 and other components. Note, portions of this design implemented in software 644, 645, 646 are stored in the one or more memories 630-632 and are executed by the one or more processors 620. The processing unit 620 may have one or more processing cores, which couples to a system bus 621 that couples various system components including the system memory 630. The system bus 621 may be any of several types of bus structures selected from a memory bus, an interconnect fabric, a peripheral bus, and a local bus using any of a variety of bus architectures.

Computing device 602 typically includes a variety of computing machine-readable media. Machine-readable media can be any available media that can be accessed by computing device 602 and includes both volatile and nonvolatile media, and removable and non-removable media. By way of example, and not limitation, computing machine-readable media use includes storage of information, such as computer-readable instructions, data structures, other executable software, or other data. Computer-storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information, and which can be accessed by the computing device 602. Transitory media such as wireless channels are not included in the machine-readable media. Machine-readable media typically embody computer readable instructions, data structures, and other executable software. In an example, a volatile memory drive 641 is illustrated for storing portions of the operating system 644, application programs 645, other executable software 646, and program data 647.

A user may enter commands and information into the computing device 602 through input devices such as a keyboard, touchscreen, or software or hardware input buttons 662, a microphone 663, a pointing device and/or scrolling input component, such as a mouse, trackball, or touch pad 661. The microphone 663 can cooperate with speech recognition software. These and other input devices are often connected to the processing unit 620 through a user input interface 660 that is coupled to the system bus 621 but can be connected by other interface and bus structures, such as a lighting port, game port, or a universal serial bus (USB). A display monitor 691 or other type of display screen device is also connected to the system bus 621 via an interface, such as a display interface 690. In addition to the monitor 691, computing devices may also include other peripheral output devices such as speakers 697, a vibration device 699, and other output devices, which may be connected through an output peripheral interface 695.

The computing device 602 can operate in a networked environment using logical connections to one or more remote computers/client devices, such as a remote computing system 680. The remote computing system 680 can a personal computer, a mobile computing device, a server, a router, a network PC, a peer device, or other common network node, and typically includes many or all of the elements described above relative to the computing device 602. The logical connections can include a personal area network (PAN) 672 (e.g., Bluetooth®), a local area network (LAN) 671 (e.g., Wi-Fi), and a wide area network (WAN) 673 (e.g., cellular network). Such networking environments are commonplace in offices, enterprise-wide computer networks, intranets, and the Internet. A browser application and/or one or more local apps may be resident on the computing device and stored in the memory.

When used in a LAN networking environment, the computing device 602 is connected to the LAN 671 through a network interface 670, which can be, for example, a Bluetooth® or Wi-Fi adapter. When used in a WAN networking environment (e.g., Internet), the computing device 602 typically includes some means for establishing communications over the WAN 673. With respect to mobile telecommunication technologies, for example, a radio interface, which can be internal or external, can be connected to the system bus 621 via the network interface 670, or other appropriate mechanism. In a networked environment, other software depicted relative to the computing device 602, or portions thereof, may be stored in the remote memory storage device. By way of example, and not limitation, remote application programs 685 as reside on remote computing device 680. It will be appreciated that the network connections shown are examples and other means of establishing a communications link between the computing devices that may be used. It should be noted that the present design can be carried out on a single computing device or on a distributed system in which different portions of the present design are carried out on different parts of the distributed computing system.

Note, an application described herein includes but is not limited to software applications, mobile applications, and programs routines, objects, widgets, plug-ins that are part of an operating system application. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as Python, C, C++, Java, HTTP, or other similar languages. Also, an algorithm can be implemented with lines of code in software, configured logic gates in hardware, or a combination of both. In an embodiment, the logic consists of electronic circuits that follow the rules of Boolean Logic, software that contain patterns of instructions, or any combination of both. A module may be implemented in hardware electronic components, software components, and a combination of both. A software engine is a core component of a complex system consisting of hardware and software that is capable of performing its function discretely from other portions of the entire complex system but designed to interact with the other portions of the entire complex system.

Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

1. An apparatus, comprising:
an appliance extension, resident on a mobile computing device, configured to perform functions with i) a monitoring module configured to monitor metrics and receive alerts regarding potential cyber threats on a system including an email system, ii) an investigative module configured to retrieve the metrics and alerts, and iii) a remote response module configured observe the metrics and alerts and send one or more control signals to an autonomous response module to take one or more actions to counter one or more detected cyber threats on the system remotely from the appliance extension,
where the appliance extension is configured to display one or more of the metrics, alerts, and one or more actions of the remote response module on an interactive user interface, where the interactive user interface is configured to receive one or more user inputs, initiated from the appliance extension, from a user to control or modify the one or more actions to be taken to counter the one or more detected cyber threats on the system, where the appliance extension is further configured to provide a secure extension of a second user interface of a cyber security appliance installed in the system, and
where instructions implemented in software for the appliance extension are configured to be stored in one or more non-transitory storage mediums to be executed by one or more processing units.

2. The apparatus of claim 1, wherein the appliance extension is further configured to display an interactive contextualised summary of one or more of the metrics, alerts, and one or more actions on the interactive user interface in a simplified human-readable format based on a compilation of data from one or more of: the monitoring module, the investigative module, the remote response module, and additional data from the system.

3. The apparatus of claim 1, wherein the one or more user inputs to control or modify the one or more actions of the autonomous response module comprises: approving one or more actions of the autonomous response module to counter the detected cyber threats; preventing the autonomous response module from performing the one or more actions; and modifying the one or more actions of the autonomous response module to counter the detected cyber threats.

4. The apparatus of claim 1, wherein the interactive user interface is further configured to receive one or more user inputs for interacting with or controlling aspects of the system including: filtering emails, modifying a display format of the metrics, holding an email, releasing an email, flagging a behaviour associated with an email, searching emails, and viewing additional metadata associated with an email.

5. The apparatus of claim 1, wherein:
the appliance extension is further configured to, in response to a user input, retrieve and display additional contextual information related to one or more of the metrics, the alerts, the one or more actions, or the detected cyber threat on the interactive user interface to allow the user to further investigate the detected cyber threats; and
the interactive user interface is configured to receive comments input by the user, the comments being associated with one or more of the metrics, alerts, or one or more actions.

6. The apparatus of claim 1, wherein the appliance extension is further configured to:
perform functions with a cyberattack simulation module configured to perform a machine-learned task of initiating and monitoring a cyberattack simulation on the system;
display, on the interactive user interface, metrics related to a progression of the simulated cyberattack, and receive one or more user inputs via the interactive user interface to modify the simulated cyberattack; and
send one or more control signals to the cyberattack simulation module to modify the simulated cyberattack.

7. The apparatus of claim 1, wherein:
the appliance extension is further configured to perform functions with a restoration module configured to perform a machine-learned task of remediating the system back to a trusted operational state after a cyber threat is countered;
the appliance extension is further configured to receive one or more recommended restoration actions from the restoration module and display the restoration actions on the interactive user interface;
the interactive user interface is configured to receive one or more inputs to approve, prevent, or modify the recommended restoration actions; and
the appliance extension is further configured to send one or more control signals to control the restoration module to perform the one or more recommended restoration actions, perform the modified recommended restoration actions, or prevent performance of the recommended restoration actions.

8. The apparatus of claim 1 wherein the appliance extension is further configured to:
receive a proactive threat notification (PTN) from an operator on the system, the PTN being indicative that a cyber threat has been detected on the system based on information from the monitoring module and the investigative module;
display, on the interactive user interface, information related to the potential cyber threat associated with the PTN and a recommended action to counter the potential cyber threat;
receive one or more user inputs to approve, prevent, or modify the recommended action; and
send one or more control signals to control the autonomous response module to perform the recommended action, perform the modified recommended action, or prevent performance of the recommended action.

9. The apparatus of claim 1 wherein:
the monitoring module and investigative module are further configured to respectively monitor and retrieve additional metrics based at least in part on one or more of: third-party data and open source intelligence to identify potential cyber threats, and the appliance extension is further configured to:
receive a common vulnerabilities and exposures (CVE) notification from the investigative module based on the additional metrics, the CVE being indicative that a potential cyber threat putting the system at risk has been identified, wherein the CVE notification comprises information indicating one or more assets on the system which are at risk from the potential cyber threat.

10. The apparatus of claim 1, wherein the appliance extension is a mobile application installed on a smart mobile device that needs to be registered, where the registered mobile application on the smart device and the cyber security appliance are configured to communicate securely via a backend server, via at least 1) using a secure protocol and 2) requiring a need to authenticate communications with a unique and verifiable signature, not a public Internet Protocol IP address, from i) an instance of the registered mobile application, ii) the cyber security appliance installed in the system, or iii) unique signatures of both the cyber security appliance and the instance of the registered mobile application.

11. A method for an appliance extension for a cyber security appliance, comprising:
configuring the appliance extension, resident on a mobile computing device, to perform functions with i) a monitoring module configured to monitor metrics and receive alerts regarding potential cyber threats on a system including an email system, ii) an investigative module configured to retrieve the metrics and alerts, and iii) a remote response module configured observe the metrics and alerts and send one or more control signals to an autonomous response module to take one or more actions to counter one or more detected cyber threats on the system remotely from the appliance extension;
configuring the appliance extension to display one or more of the metrics, alerts, and one or more actions of the remote response module on an interactive user interface;
configuring the interactive user interface to receive one or more user inputs, initiated from the appliance extension, from a user to control or modify the one or more actions to be taken to counter the one or more detected cyber threats on the system; and
configuring the appliance extension to provide a secure extension of a second user interface of a cyber security appliance installed in the system.

12. The method of claim 11, further comprising configuring the appliance extension to display an interactive contextualised summary of one or more of the metrics, alerts, and one or more actions on the interactive user interface in a simplified human-readable format based on a compilation of data from one or more of: the monitoring module, the investigative module, the remote response module, and additional data from the system.

13. The method of claim 11, wherein the one or more user inputs to control or modify the one or more actions of the autonomous response module comprises: approving one or more actions of the autonomous response module to counter the detected cyber threats; preventing the autonomous response module from performing the one or more actions; modifying the one or more actions of the autonomous response module to counter the detected cyber threats.

14. The method of claim 11, further comprising:
configuring the appliance extension to, in response to a user input, retrieve and display additional contextual information related to one or more of the metrics, the alerts, the one or more actions, or the detected cyber threat on the interactive user interface to allow the user to further investigate the detected cyber threats; and
configuring the interactive user interface to receive comments input by the user, the comments being associated with one or more of the metrics, alerts, or one or more actions.

15. The method of claim 11, further comprising configuring the appliance extension to:
perform functions with a cyberattack simulation module configured to perform a machine-learned task of initiating and monitoring a cyberattack simulation on the system;
display, on the interactive user interface, metrics related to a progression of the simulated cyberattack, and receive one or more user inputs via the interactive user interface to modify the simulated cyberattack; and
send one or more control signals to the cyberattack simulation module to modify the simulated cyberattack.

16. The method of claim 11, further comprising:
configuring the appliance extension to perform functions with a restoration module configured to perform a machine-learned task of remediating the system back to a trusted operational state after a cyber threat is countered;
configuring the appliance extension to receive one or more recommended restoration actions from the restoration module and display the restoration actions on the interactive user interface;
configuring the interactive user interface to receive one or more inputs to approve, prevent, or modify the recommended restoration actions; and
configuring the appliance extension to send one or more control signals to control the restoration module to perform the one or more recommended restoration actions, perform the modified recommended restoration actions, or prevent performance of the recommended restoration actions.

17. The method of claim 11, further comprising configuring the appliance extension to:
receive a proactive threat notification (PTN) from an operator on the system, the PTN being indicative that a cyber threat has been detected on the system based on information from the monitoring module and the investigative module;
display, on the interactive user interface, information related to the potential cyber threat associated with the PTN and a recommended action to counter the potential cyber threat;
receive one or more user inputs to approve, prevent, or modify the recommended action; and
send one or more control signals to control the autonomous response module to perform the recommended action, perform the modified recommended action, or prevent performance of the recommended action.

18. The method of claim 11, wherein the monitoring module and investigative module are further configured to respectively monitor and retrieve additional metrics based at least in part on one or more of: third-party data and open source intelligence to identify potential cyber threats, and the method further comprises:
configuring the appliance extension to receive a common vulnerabilities and exposures (CVE) notification from the investigative module based on the additional metrics, the CVE being indicative that a potential cyber threat putting the system at risk has been identified, wherein the CVE notification comprises information indicating one or more assets on the system which are at risk from the potential cyber threat.

19. The method of claim 11, wherein the appliance extension is a mobile application installed on a smart mobile device that needs to be registered, and the method further comprises:
configuring the registered mobile application on the smart device and the cyber security appliance to communicate securely via a backend server, via at least 1) using a secure protocol and 2) requiring a need to authenticate communications with a unique and verifiable signature, not a public Internet Protocol IP address, from i) an instance of the registered mobile application, ii) the cyber security appliance installed in the system, or iii) unique signatures of both the cyber security appliance and the instance of the registered mobile application.

20. A non-transitory computer readable medium comprising computer readable code operable, when executed by one or more processing apparatuses in a computer system to instruct a computing device to perform the method of claim 11.
